(19) United States
(12) Patent Application Publication
(10) Pub. No.: US 2013/0227127 A1
(43) Pub. Date: Aug. 29, 2013

(54) SCHEDULE MANAGEMENT METHOD AND SCHEDULE MANAGEMENT SERVER

(71) Applicants: Yuya Takano, Ichikawa (JP); Hirokazu Uchi, Tokyo (JP)

(72) Inventors: Yuya Takano, Ichikawa (JP); Hirokazu Uchi, Tokyo (JP)

(73) Assignee: HITACHI, LTD., Tokyo (JP)

(21) Appl. No.: 13/816,668

(22) PCT Filed: Aug. 23, 2010
(86) PCT No.: PCT/JP2010/064186

§ 371 Date: May 17, 2013

(51) Int. Cl. H04L 29/08

(52) U.S. Cl. CPC H04L 67/1031
USPC 709/224

(57) ABSTRACT

A reservation method of computer resources having short idle periods is provided. A schedule management method includes: a terminal; computers that perform tasks; and a schedule management server that manages the allocation of the computers. Each computer includes a virtual machine monitor that manages virtual computers. The schedule management server includes a schedule management part that manages reservation information including reservation state of each virtual computer, and creates reservation schedules for allocating the virtual computers to the tasks. The schedule creation method includes extracting a free period of each virtual computer, and creating a reservation schedule that secures a period that coincides with the reservation request period by reserving one virtual computer, and another virtual computer so that the end-point of a reservation period configured in the free period of the one virtual computer coincides with or overlaps the start-point of a reservation period configured in the free period of the another computer.

### TECHNICAL FIELD

The present invention relates to allocation scheduling of virtual computers that performs users' tasks and, more particularly to allocation scheduling of virtual computers with the use of a hot migration.

In recent years, systems that build plural virtual computers on plural physical computers and perform mission-critical tasks on these virtual computers have been widely spreading. When a mission-critical task is performed, it is necessary that relevant tasks are also performed in parallel with the mission-critical task. Therefore, computer resources needed to perform a mission-critical task have to be secured in advance. In other words, the allocation of computer resources has to be determined in advance.

Hereinafter, securing a computer resource necessary for performing a task in advance will be described as “reserving” a computer resource.

Reserved computer resources that are occupied by a task cannot be reserved by other tasks, that is, these computer resources become in occupied states.

When a computer resource is reserved, the mission-critical task must continuously be performed. The amount of resources according to the task therefore need be reserved during a certain period represented by the units of hours, days, or months.

For example, Japanese Unexamined Patent Application Publication No. 2007-193471 discloses a technology in which computer resources having a free period equal to or longer than a reservation period that a user needs are searched, and the computer resource having the longest idle period that includes the desired reservation period is reserved. According to the above Japanese Unexamined Patent Application Publication, in the case where plural computer resources have already been reserved, a computer resource that can provide the longest desired reservation period is searched and reserved on the basis of the research result. This reduces the idle periods of computer resources, and enables many reservations to be accepted.

### SUMMARY

According to the above-described Japanese Unexamined Patent Application Publication, if there is no computer resource that can provide a free time equal to or longer than a desired reservation time a user needs, any computer resource can not be reserved. According to the invention of the above-described Japanese Unexamined Patent Application Publication, because only computer resources that have free times equal to or longer than the desired reservation time can be the targets of the reservation, computer resources that have free times shorter than the desired reservation time cannot be the targets of the reservation.

Therefore, although the invention of the above-described Japanese Unexamined Patent Application Publication has an advantageous effect to utilize the long idle periods of computer resources, it cannot utilize computer resources that have short idle periods as effectively as possible.

One object of the present invention is to provide a reservation method of computer resources in which computer resources having short idle periods is taken into consideration.

A typical example of the present invention is as follows. To put it concretely, the present invention relates to a schedule management method including: a management computer that a user operates; plural computers that performs the user task; a schedule management server that manages the allocation of the plurality of computers that perform the user task. The management computer includes: a first processor; a first memory that is connected to the first processor; a first network interface that is connected to the first processor; and an input/output part that is connected to the first processor. Each of the plurality of computers includes: a second processor; a second memory that is connected to the second processor; and a second network interface that is connected to the second processor. The schedule management server includes: a third processor; a third memory that is connected to the third processor; and a third network interface that is connected to the third processor. The second memory includes: a virtual machine monitor that manages a plurality of virtual computers provided by virtually dividing the physical resources of the plurality computers; and an operating system that runs on each of the virtual computers, and performs the user task. The third memory includes: a request receiving part that receives a reservation request for reserving virtual computers to be allocated to the user task; and a schedule management part that manages reservation information including the reservation state of each virtual computer, and creates a reservation schedule for each virtual computer allocated to the user task. The schedule creation method includes: a first step in which the request receiving part receives the reservation request including a reservation request period that is wanted by the user and sent from the terminal; a second step in which the schedule management part extracts a free period of each virtual computer, during which a new reservation period can be made, with reference to the reservation information; a third step in which the schedule management part selects computers on which reservable virtual computers run on the basis of the received reservation request and the extracted free period of each virtual computer; a fourth step in which a reservation schedule that secures a period that coincides with the reservation request period is created by reserving one virtual computer which runs on the selected computer, and another virtual computer which runs on the decided computer so that the end-point of a reservation period configured in the free period of the one virtual computer coincides with or overlaps the start-point of a reservation period configured in the free period of the another computer; a fifth step in which the schedule management part updates the reservation information on the basis of the created reservation schedule; and a sixth step in which the schedule management part migrates the user task from the virtual computer that is performing the user task to another reserved virtual computer on the updated reservation information.

According to the present invention, even if there is no virtual computer that has a free period equal to or longer than a reservation request period, a schedule that enables the reservation request period to be continuously configured across the free times of plural virtual computers can be created. Therefore, the short free times of plural virtual computers can be effectively used, and a reservation request time can be provided by the present invention in continuous occupied states of plural virtual computers as if only one virtual computer were reserved.

### BRIEF DESCRIPTION OF THE DRAWINGS

FIG. 1 is a block diagram showing a configuration example of a computer system according to a first embodiment of the present invention.

FIG. 2 is a block diagram describing a apparatus configuration of a computer according to the first embodiment of the present invention.

FIG. 3 is a block diagram describing a apparatus configuration of a management client according to the first embodiment of the present invention.

FIG. 4 is a block diagram describing a apparatus configuration of a schedule management server according to the first embodiment of the present invention.

FIG. 5 is an explanatory diagram showing an example of a candidate list according to the first embodiment of the present invention.

FIG. 6 is an explanatory diagram showing an example of a provisional reservation period list according to the first embodiment of the present invention.

FIG. 7 is an explanatory diagram showing an example of a reservation model according to the first embodiment of the present invention.

FIG. 8 is an explanatory diagram showing an example of configuration information according to the first embodiment of the present invention.

FIG. 9 is an explanatory diagram showing an example of migration information according to the first embodiment of the present invention.

FIG. 10 is an explanatory diagram showing an example of evaluation definition information according to the first embodiment of the present invention.

FIG. 11 is an explanatory diagram showing an example of schedule information according to the first embodiment of the present invention.

FIG. 12 is an explanatory diagram showing an example of schedule information according to the first embodiment of the present invention.

FIG. 13 is an explanatory diagram showing an example of reservation state information according to the first embodiment of the present invention.

FIG. 14A is an explanatory diagram showing an example of free resource information according to the first embodiment of the present invention.

FIG. 14B is an explanatory diagram showing an example of free resource information according to the first embodiment of the present invention.

FIG. 15 is an explanatory diagram showing an example of an operation screen output to an I/O device according to the first embodiment of the present invention.

FIG. 16 is a flowchart describing an outline of reservation processing executed by the schedule management server according to the first embodiment of the present invention.

FIG. 17 is an explanatory diagram showing an example of a reservation request stored in a memory according to the first embodiment of the present invention.

FIG. 18 is a flowchart describing search processing according to the first embodiment of the present invention.

FIG. 19 is a flowchart describing candidate list creation processing according to the first embodiment of the present invention.

FIG. 20 is a flowchart describing provisional reservation period list creation processing according to the first embodiment of the present invention.

FIG. 21A is an explanatory diagram showing a concrete example of candidate list creation processing according to the first embodiment of the present invention.

FIG. 21B is an explanatory diagram showing a concrete example of candidate list creation processing according to the first embodiment of the present invention.

FIG. 21C is an explanatory diagram showing a concrete example of candidate list creation processing according to the first embodiment of the present invention.

FIG. 21D is an explanatory diagram showing a concrete example of candidate list creation processing according to the first embodiment of the present invention.

FIG. 22A is an explanatory diagram showing a concrete example of provisional reservation period list creation processing according to the first embodiment of the present invention.

FIG. 22B is an explanatory diagram showing a concrete example of provisional reservation period list creation processing according to the first embodiment of the present invention.

FIG. 23 is a flowchart describing reservation model creation processing according to the first embodiment of the present invention.

FIG. 24 is a flowchart describing reservation configuration processing according to the first embodiment of the present invention.

FIG. 25 is a flowchart describing migration processing according to the first embodiment of the present invention.

FIG. 26A is a flowchart describing candidate list creation processing according to a second embodiment of the present invention.

FIG. 26B is a flowchart describing candidate list creation processing according to the second embodiment of the present invention.

### DETAILED DESCRIPTION

Embodiments of the present invention will be describe with reference to the accompanying drawings hereinafter.

### First Embodiment

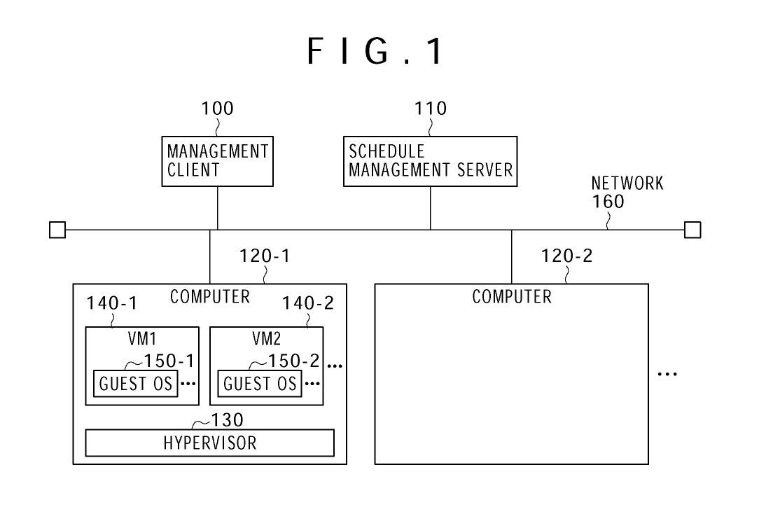

FIG. 1 is a block diagram showing a configuration example of a computer system according to a first embodiment of the present invention.

The computer system of the first embodiment comprises a management client 100, a schedule management server 110, and computers 120-1 and 120-2.

The management client 100, the schedule management server 110, and the computers 120-1 and 120-2 are connected to each other via a network 160. As the network 160, a LAN is conceivable, for example. In addition, the connection method of the above apparatuses in this embodiment is not limited to the method with the use of the network 160.

The management client 100 is a computer that a user operates.

The schedule management server 110 manages the allocation of virtual computers (virtual machines: a virtual machine is referred to as a VM hereinafter) that perform tasks. The computers 120-1 and 120-2 perform user tasks. In addition, the computers 120-1 and 120-2 are management targets of the schedule management server 110.

As shown in FIG. 1, the computer 120-1 includes a hypervisor 130. The hypervisor 130 manages a VM1 (140-1) and a VM2 (140-2). In addition, because the computer 120-2 has a configuration similar to that of the computer 120-1, the explanation about the computer 120-2 will be omitted.

Hereinafter, if it is not necessary to distinguish between the computers 120-1 and 120-2, they are described as the computers 120. In addition, if it is not necessary to distinguish between the VM1 (140-1) and the VM2 (140-2), they are described as the VMs 140.

In the first embodiment, VMs 140 created on the computers 120 are allocated to various tasks as computer resources.

The hypervisor 130 creates VMs 140 by logically dividing computer resources that are provided by the computers 120, and manages the created VMs 140 as well. In addition, the hypervisor 130 can release the computer resources by deleting the VMs 140.

In the example shown in FIG. 1, the hypervisor 130 manages the VM1 (140-1) and the VM2 (140-2) that are created on the computer 120-1.

A VM 140 executes a guest OS corresponding to a user task. In the example shown in FIG. 1, the VM 140-1 executes the guest OS 150-1, and the VM 140-2 executes the guest OS 150-2.

In addition, applications other than the guest OSs 150-1 and 150-2 can be executed on the VMs 140.

A user reserves a VM 140 that performs his/her task by designating a usage period during which the user wants to use the VM 140. Hereinafter, a usage period during which a user wants to use a VM 140 will be referred to as a user request period. The reserved VM 140 falls under an occupied state where other tasks can not reserve the VM 140.

In the embodiment of the present invention, if the schedule management server 110, which receives a new reservation request of a VM 140, cannot make a reservation that satisfies the user request period at one VM 140, the schedule management server 110 creates an allocation schedule of VMs 140 that satisfy the user request period.

To put it concretely, the schedule management server 110 checks the reservation states of plural VMs 140, and extracts the free times of the VMs 140. Here, the free time of a VM 140 represents a time during which the VM 140 is not reserved.

The schedule management server 110 reserves respective VMs 140 so that the collection of the reservation periods of respective VMs 140 may form one continuous reservation period. In other words, the schedule management server 110 connects the free times of respective VMs 140 to create an allocation schedule of the VMs 140 that satisfies the user request period.

This can create occupied states of free times that satisfy the user request period. In other words, a reservation state equivalent to the state where the user request period is reserved at one VM 140 is created. Therefore, the task can be continuously performed during the user request period.

In the first embodiment, when a task that is being performed on one VM 140 is transferred to another VM 140, a migration is executed. In the first embodiment, when the schedule management server 110 creates an allocation schedule of VMs 140, the schedule management server 110 configures a provisional reservation period that is a migration execution period in the free times of individual VMs 140. This makes it possible to execute the migration safely and securely.

Next, the apparatus configurations of the management client 100, the schedule management server 110, and the computer 120 will be explained.

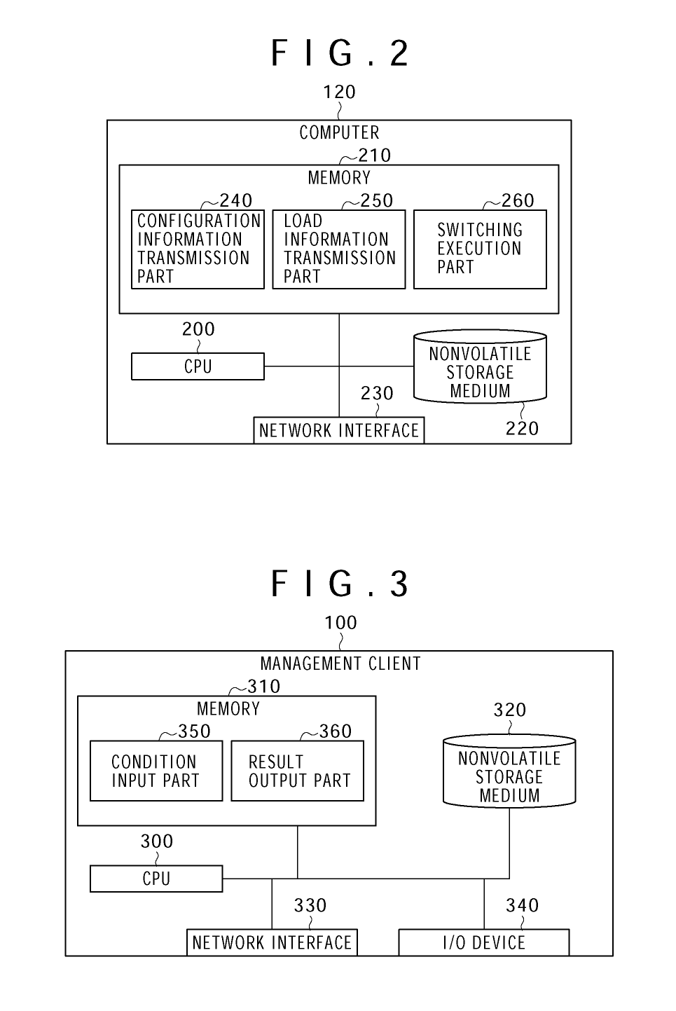

FIG. 2 is a block diagram describing an apparatus configuration of a computer 120 according to the first embodiment of the present invention.

The computer 120 includes a CPU 200, a memory 210, a nonvolatile storage medium 220, and a network interface 230. The CPU 200, the memory 210, the nonvolatile storage medium 220, and the network interface 230 are connected to each other via an internal bus and the like.

The CPU 200 executes programs stored on the memory 210. This puts the functions of the computer 120 into practice.

The memory 210 stores programs that the CPU 200 executes and information necessary for the CPU 200 to execute the programs. To put it concretely, the memory 210 stores a configuration information transmission part 240, a load information transmission part 250, and a switching execution part 260. In addition, the memory 210 can store information other than the above.

The configuration information transmission part 240 transmits the configuration information of the VMs 140 created on the computer 120 to the schedule management server 110.

In addition, it is conceivable that the configuration information transmission part 240 transmits the configuration information of the VMs 140 on the computer 120 periodically or when the configuration information of the VMs 140 is changed. Alternatively, the configuration information transmission part 240 can be configured to transmit the configuration information of the VMs 140 on receiving an acquisition request of the configuration information of the VMs 140 from the schedule management server 110.

The load information transmission part 250 acquires load information of the VMs 140 created on the computer 120, and transmits the acquired load information to the schedule management server 110.

In addition, the load information transmission part 250 transmits the acquired load information periodically or on receiving an acquisition request of the load information from the schedule management server 110.

The switching execution part 260 executes a migration when the switching execution part 260 receives a migration execution command from the schedule management server 110. In the first embodiment, the switching execution part 260 executes a hot migration in which a migration is executed between VMs 140 both of which reside in the same computer 120.

In addition, the configuration information transmission part 240, the load information transmission part 250, and the switching execution part 260 are managed by the hypervisor 130.

The nonvolatile storage medium 220 stores various information necessary for the computer 120. The nonvolatile storage medium 220 can be, for example, an HDD or an SSD.

The nonvolatile storage medium 220 stores, for example, programs that are transferred to the memory 210 when the programs are executed. The CPU 200 reads out a specified program to be executed from the nonvolatile medium 220 to write on the memory 220, and executes the read-out program.

The network interface 230 is an interface used for connecting the internal devices and parts to external apparatuses via a network.

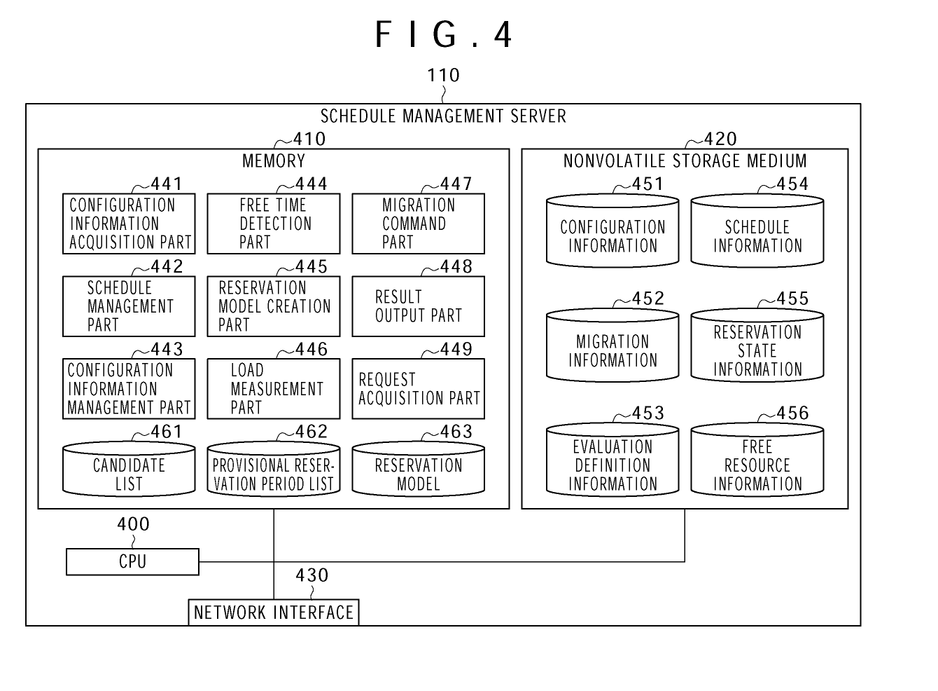

FIG. 3 is a block diagram describing a apparatus configuration of a management client 100 according to the first embodiment of the present invention.

The management client 100 includes a CPU 300, a memory 310, a nonvolatile storage medium 320, a network interface 330, and an I/O device 340. The CPU 300, the memory 310, the nonvolatile storage medium 320, the network interface 330, and the I/O device 340 are connected to each other via an internal bus and the like.

The CPU 300 executes programs stored in the memory 310. This puts the functions of the management client 100 into practice.

The memory 310 stores programs that the CPU 300 executes and information necessary for the CPU 300 to execute the programs. To put it concretely, the memory 310 includes a condition input part 350, and a result output part 360. In addition, the memory 310 can store information other than the above.

With the use of the condition input part 350, a condition to create a reservation model, which will be described later, is input. In addition, the condition input part 350 transmits the input condition to the schedule management server 110.

The result output part 360 outputs the results of various processing.

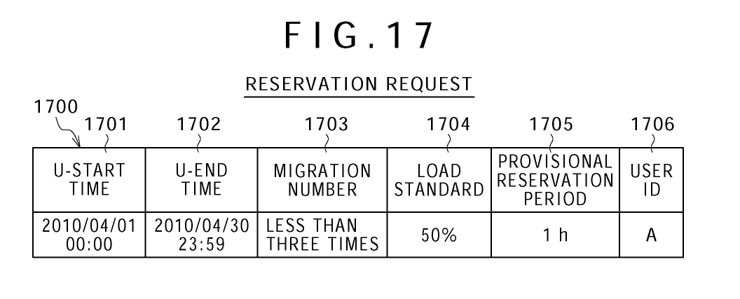

In addition, an example of an operation screen brought about by the condition input part 350 and the result output part 360 will be described later with reference to FIG. 15.

The nonvolatile storage medium 320 stores various information necessary for the management client 100. The nonvolatile storage medium 320 can be, for example, an HDD or an SSD.

The nonvolatile storage medium 320 stores, for example, programs that are transferred to the memory 310 when the programs are executed. The CPU 300 reads out a specified program to be executed from the nonvolatile medium 320 to write on the memory 310, and executes the read-out program.

The network interface 330 is an interface used for connecting the internal devices and parts to external apparatuses via a network.

The I/O device 340 is a device used for inputting various information or displaying various processing results. The I/O device 340 includes, for example, a keyboard, a mouse, and a display.

The condition input part 350 acquires information input from the I/O device 340, and transmits the acquired information to the schedule management server 110 and the like. The result output part 360 outputs information received from the schedule management 110 and the like to the I/O device 340.

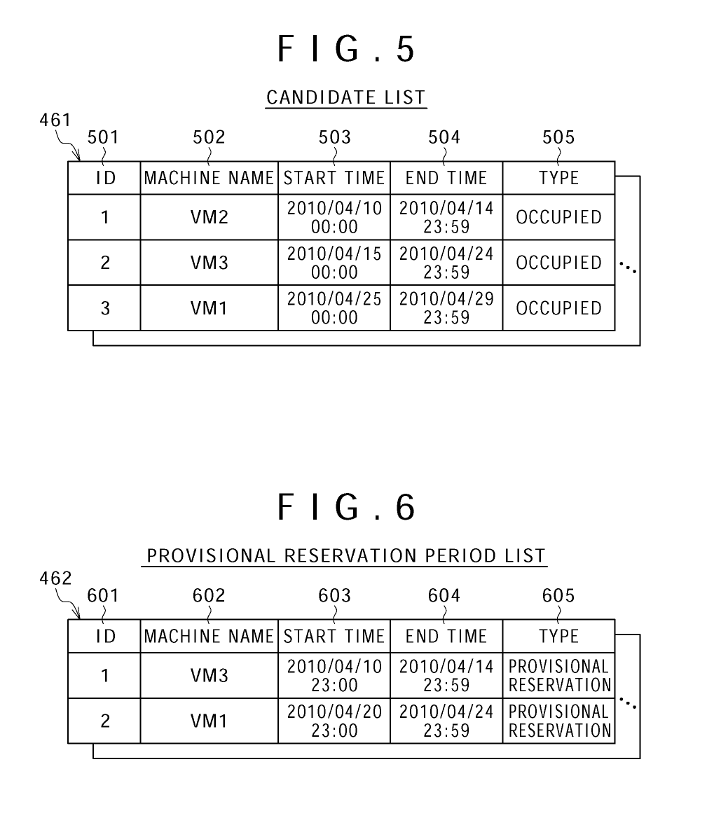

FIG. 4 is a block diagram describing a apparatus configuration of the schedule management server 110 according to the first embodiment of the present invention.

The schedule management server 110 includes a CPU 400, a memory 410, a nonvolatile storage medium 420, and a network interface 430. The CPU 400, the memory 410, the nonvolatile storage medium 420, and the network interface 430 are connected to each other via an internal bus and the like.

The CPU 400 executes programs stored on the memory 410. This puts the functions of the schedule management server 110 into practice.

The memory 410 stores programs that the CPU 400 executes and information necessary for the CPU 400 to execute the programs. To put it concretely, the memory 410 includes a configuration information acquisition part 441, a schedule management part 442, a configuration information management part 443, a free time detection part 444, a reservation model creation part 445, a load measurement part 446, a migration command part 447, a result output part 448, and a request acquisition part 449. In addition, the memory 410 can store information other than the above.

The configuration information acquisition part 441 acquires VM 140 configuration information transmitted from the configuration information transmission part 240 of each computer 120.

The configuration information acquisition part 441 acquires the VM 140 configuration information by transmitting a acquisition request for acquiring the VM 140 configuration information to each computer 120. It is conceivable that the configuration information acquisition part 441 transmits the acquisition request periodically or when the schedule management part 442 starts executing reservation processing.

The schedule management part 442 manages the reservation states of VMs 140, and executes reservation processing for reserving VMs 140.

The configuration information management part 443 manages configuration information transmitted from the configuration information transmission part 240 of each computer 120. The configuration information management part 433 stores the acquired VM 140 configuration information in configuration information 451.

The free time detection part 444 detects the free times of VMs 140. In addition, in the first embodiment, the free times of the VMs 140 are also referred to as the free resources of the VMs 140.

The reservation model creation part 445 creates a reservation model on the basis of the free times of VMs 140 detected by the free time detection part 444. Here, the reservation model represents an allocation schedule of VMs 140 that satisfy a user request period.

The load measurement part 446 acquires the load information of a VM 140 at a migration destination during a provisional reservation period. To put it concretely, the load measurement part 446 transmits a load information acquisition request for acquiring the load information of the VM 140 at the migration destination. A computer 120 that receives the load information acquisition request acquires the load information of the VM 140 to be created on itself. In addition, the load information transmission part 250 of the computer 120 transmits the acquired load information to the load measurement part 446.

The migration command part 447 orders the computer 120 to execute a migration. To put it concretely, the migration command part 447 transmits a migration execution command to the computer 120. The computer 120 that receives the migration execution command causes the switching execution part 260 to execute the migration.

The result output part 448 transmits the processing results such as a reservation model and the like created by the reservation model creation part 445 to the management client 100.

The request acquisition part 449 acquires a reservation request transmitted from the management client 100, and manages the acquired reservation request. Here, the reservation request represents a request for reserving a new VM 140.

In addition, the memory 410 stores a candidate list 461, a provisional reservation list 462, and a reservation model 463.

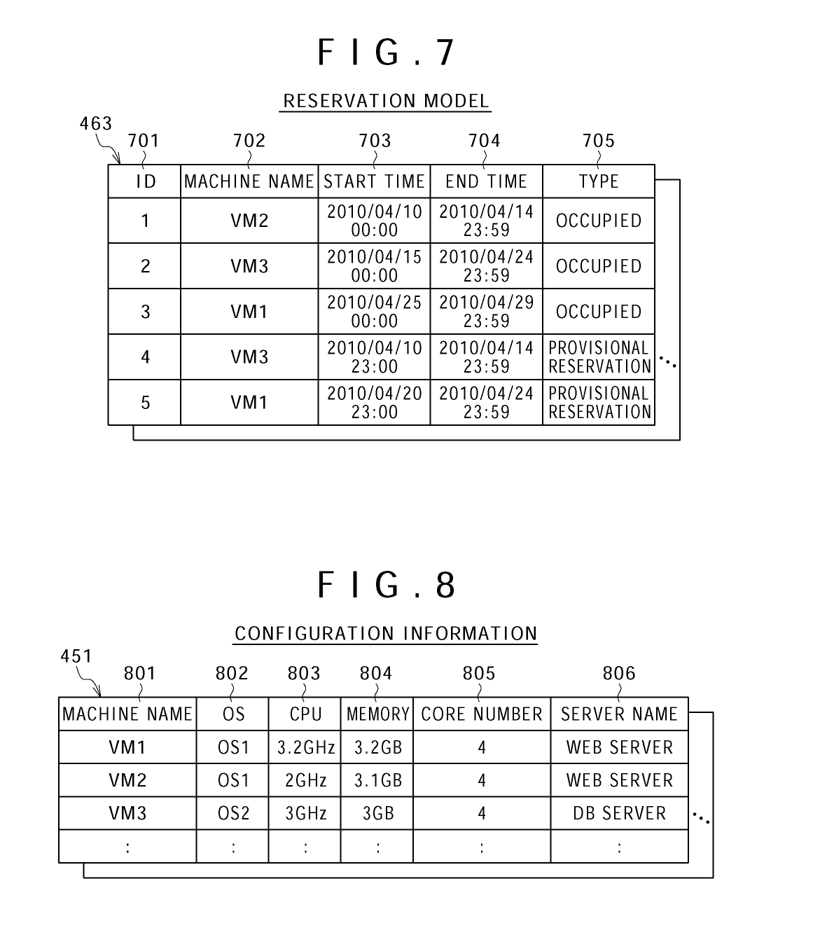

The candidate list 461 stores reservable VMs 140, that is, VMs 140 that have configurable reservation periods. The candidate list 461 will be described in detail with reference to FIG. 5 later.

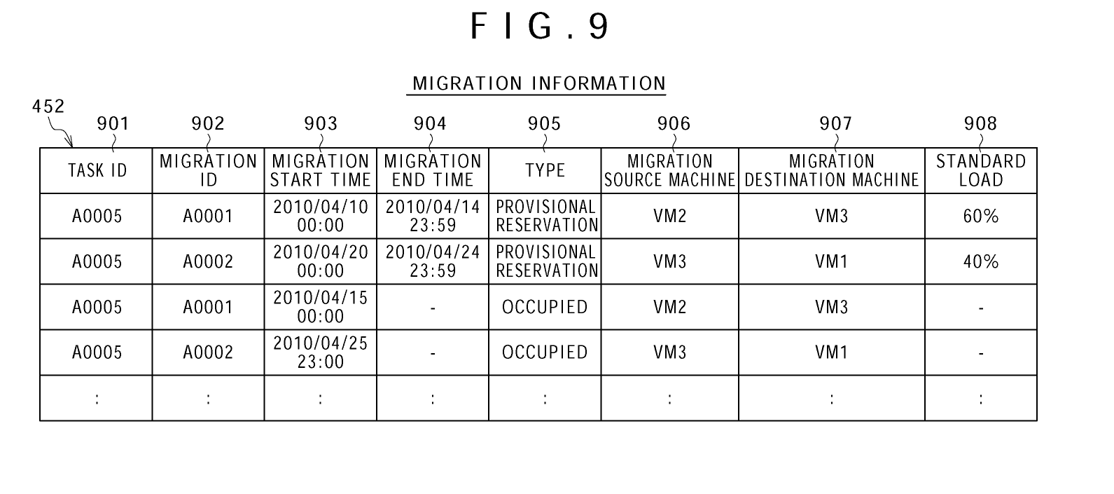

The provisional reservation list 462 stores information about VMs 140 that have configurable reservation periods. The provisional reservation list 462 will be described in detail with reference to FIG. 6 later.

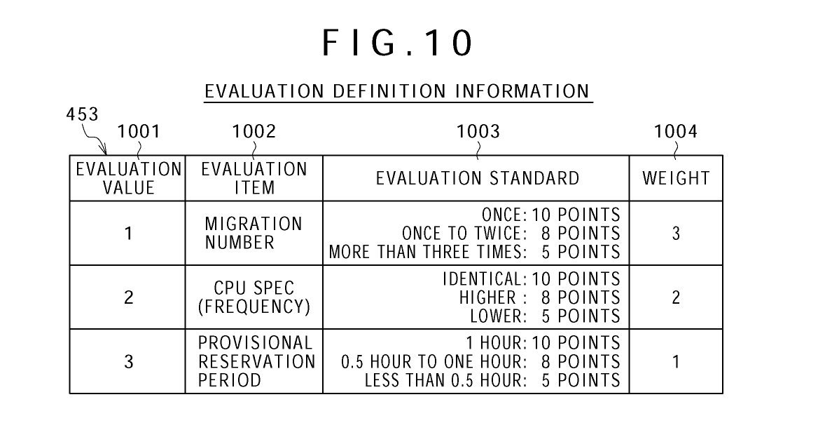

The reservation model 463 stores information about the reservation models. The reservation model 463 will be described in detail with reference to FIG. 7 later.

The nonvolatile storage medium 420 stores various information necessary for the management client 100. The nonvolatile storage medium 420 can be, for example, an HDD or an SSD.

The nonvolatile storage medium 420 stores configuration information 451, migration information 452, evaluation definition information 453, schedule information 454, reservation state information 455, and free resource information 456.

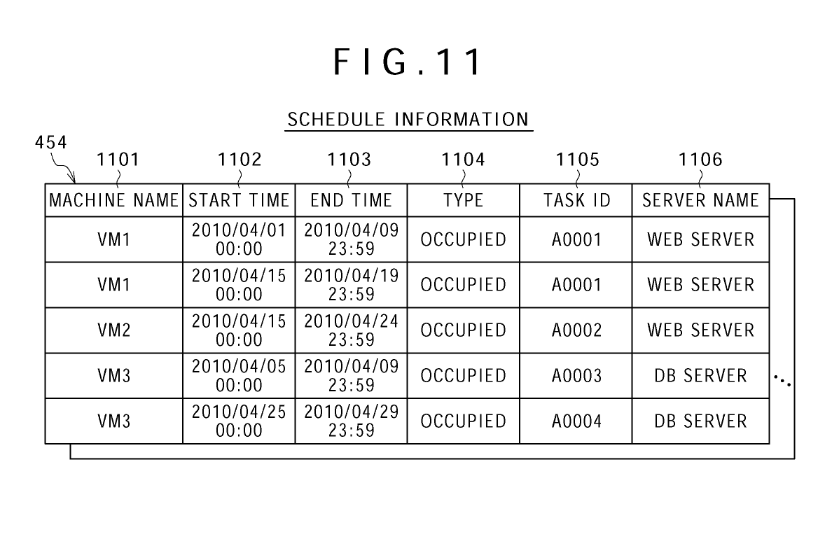

The configuration information 451 stores the VM 140 configuration information acquired from each computer 120. The configuration information 451 will be described in detail with reference to FIG. 8 later.

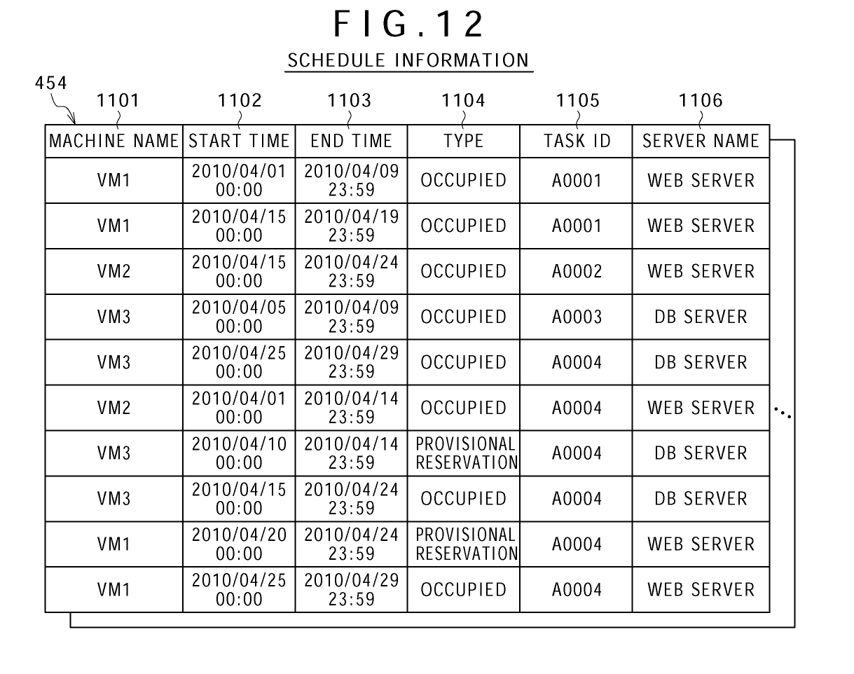

The migration information 452 stores information about migration schedules. The migration schedule information 452 will be described in detail with reference to FIG. 9 later.

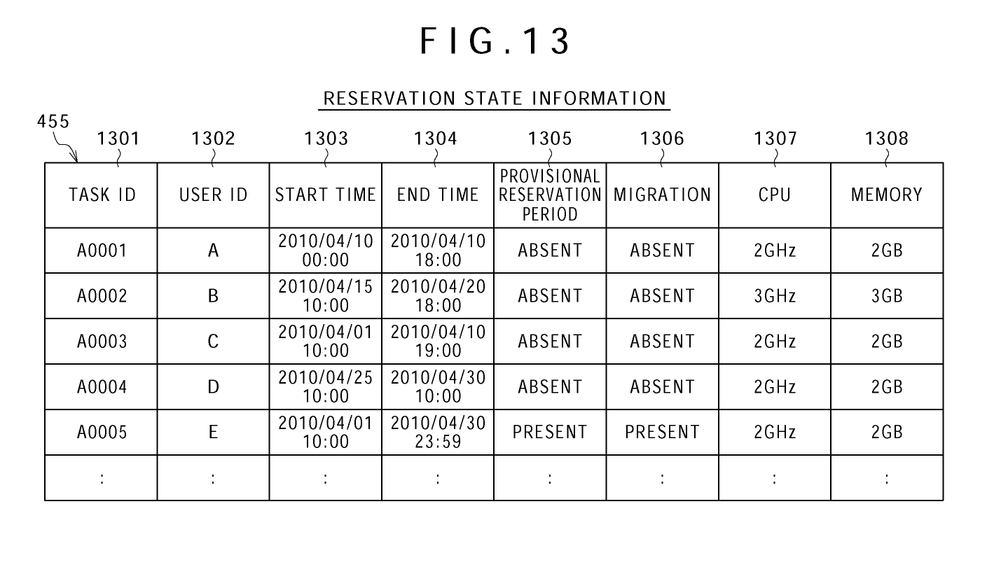

The evaluation definition information 453 stores definition information for calculating evaluation values that represent the effectiveness of created reservation models. The evaluation definition information 453 will be described in detail with reference to FIG. 10 later.

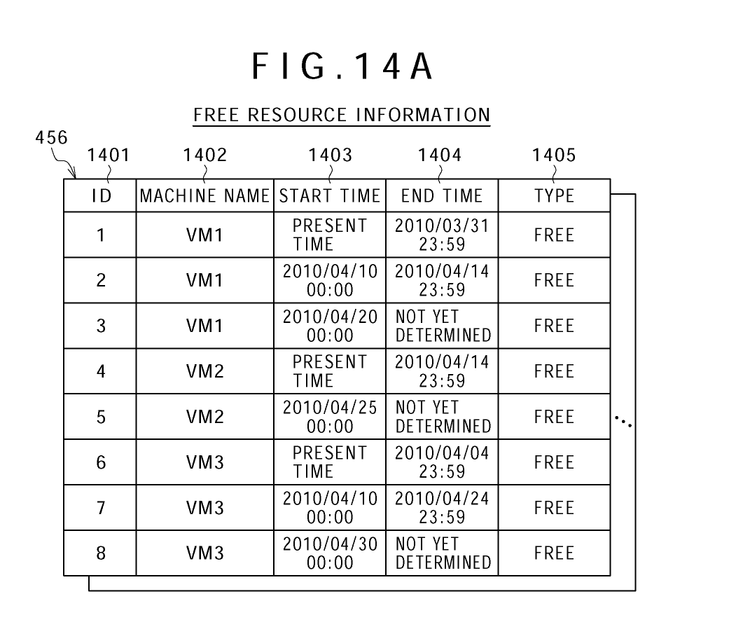

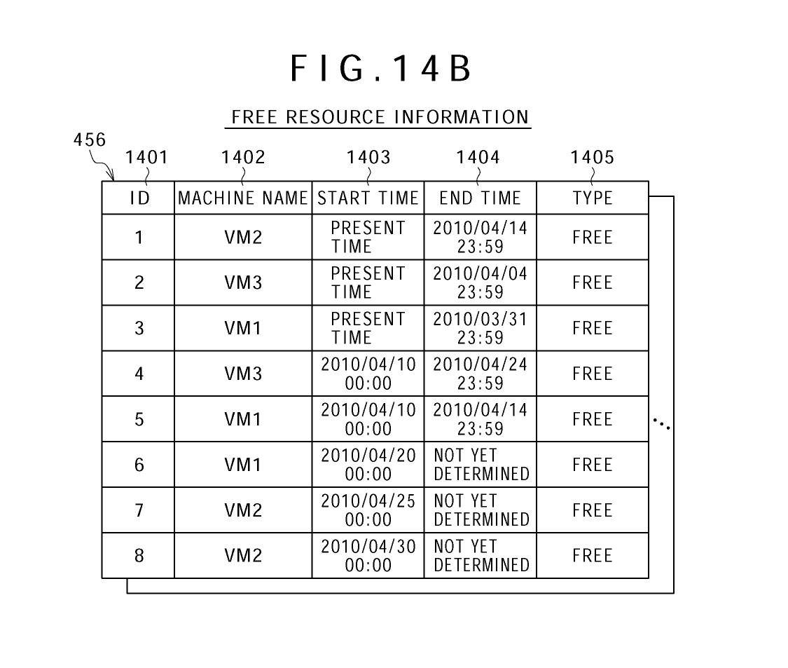

The schedule information 454 stores an allocation schedule of each VM 140. To put it concretely, information about a reservation period and a provisional reservation period configured for each VM 140 is stored. The schedule information 454 will be described in detail with reference to FIG. 11 and FIG. 12 later.

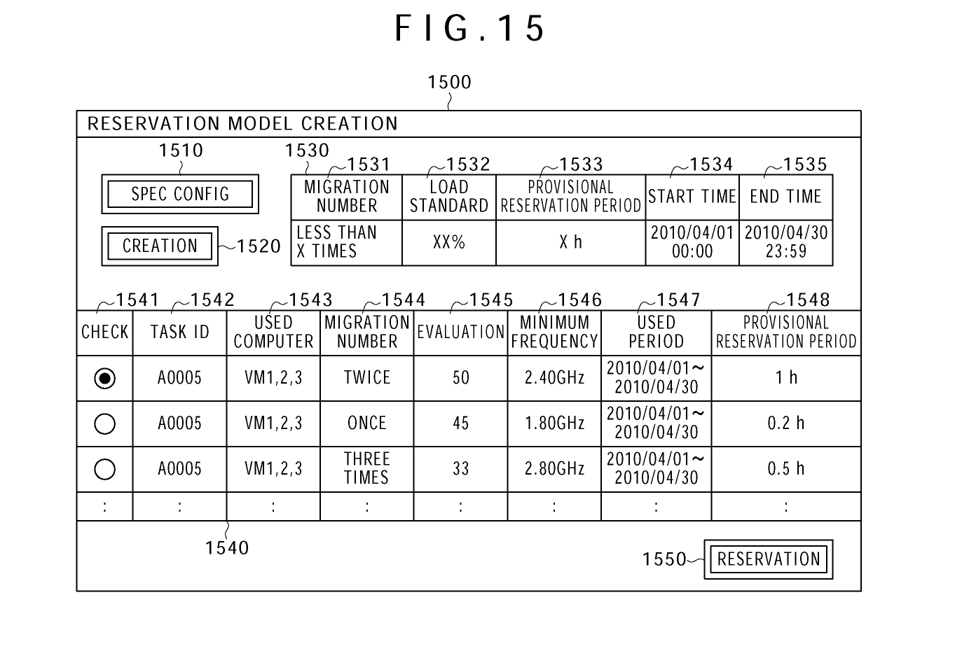

The reservation state information 455 stores information about reservation states of VMs 140 for each task. The reservation state information 455 will be described in detail with reference to FIG. 13 later.

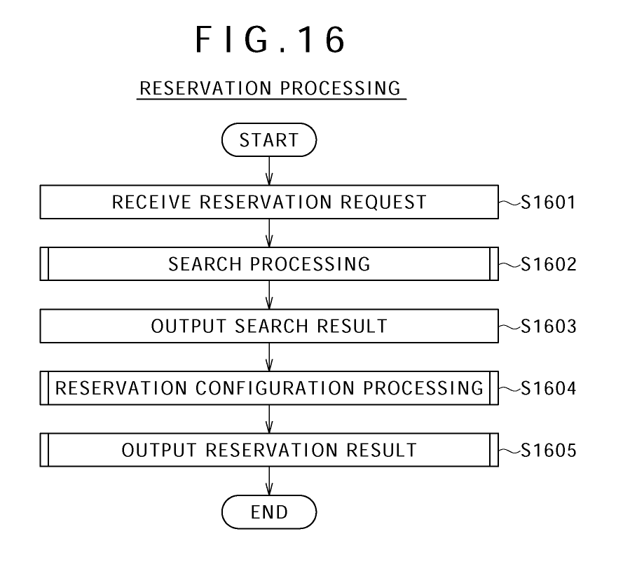

The free resource information 456 stores information about free times of VMs 140. The free resource information 456 will be described in detail with reference to FIG. 14 later.

In the first embodiment, the free times of the VMs 140 are used as free resources.

FIG. 5 is an explanatory diagram showing an example of a candidate list 461 according to the first embodiment of the present invention.

As shown in FIG. 5, there is one candidate list 461 for one candidate list creation condition. Here, a candidate list creation condition is a condition for creating a candidate list 461.

The candidate list 461 includes five columns, and their names are ID 501, Machine Name 502, Start Time 503, End Time 504, and Type 505.

The column ID 501 stores identifiers used for identifying respective records recorded in the candidate list 461.

The column Machine Name 502 stores identifiers used for identifying reservable VMs 140.

The columns Start Time 503 and End Time 504 show reservation periods configurable in VMs 140 shown by the column Machine Name 502. To put it concretely, the column Start Time 503 shows the start times of the configurable reservation periods, and the column End Time 504 shows the end times of the configurable reservation periods.

The column Type 505 stores information showing reservation types. Because the candidate list 461 stores information about the reservable VMs 140, signs “occupied” are stored in the column Type 505.

FIG. 6 is an explanatory diagram showing an example of a provisional reservation period list 462 according to the first embodiment of the present invention.

As shown in FIG. 6, there is one provisional reservation period list 462 for one candidate list 461.

The provisional reservation list 462 includes five columns, and their names are ID 601, Machine Name 602, Start Time 603, End Time 604, and Type 605.

The column ID 601 stores identifiers used for identifying respective records recorded in the provisional reservation list 462.

The column Machine Name 602 stores identifiers used for identifying VMs 140 in which provisional reservation periods can be configured.

The columns Start Time 603 and End Time 604 show provisional reservation periods configurable in VMs 140 shown by the column Machine Name 602. To put it concretely, the column Start Time 603 shows the start times of the configurable provisional reservation periods, and the column End Time 604 shows the end times of the configurable provisional reservation periods.

The column Type 605 stores information showing a reservation type. Because the provisional reservation period list 462 records information about the VMs 140 in which provisional reservation periods are configured, the column Type 605 stores signs “provisionally reserved”.

FIG. 7 is an explanatory diagram showing an example of a reservation model 463 according to the first embodiment of the present invention.

As shown in FIG. 7, there is one reservation period list 463 for one candidate list 461.

The reservation model 463 includes five columns, and their names are ID 701, Machine Name 702, Start Time 703, End Time 704, and Type 705.

The column ID 701 corresponds to the columns ID 501 and ID 601; the column Machine Name 702 corresponds to the columns Machine Name 502 and Machine Name 602; the column Start Time 703 corresponds to the columns Start Time 503 and Start Time 603; the column End Time 704 corresponds to the columns End Time 504 and End Time 604; and the column Type 705 corresponds to the columns Type 505 and Type 605, therefore the explanation of these columns is omitted.

FIG. 8 is an explanatory diagram showing an example of configuration information 451 according to the first embodiment of the present invention.

As shown in FIG. 8, there is one piece of configuration information 451 for one computer 120.

The configuration information 451 includes six columns, and their names are Machine Name 801, OS 802, CPU 803, Memory 804, Core Number 805, and Server Name 806.

The column Machine Name 801 stores identifiers used for uniquely identifying respective VMs 140 on the computers 120.

The column OS 802 stores identifiers used for identifying respective guest OSs 150 executed on the VMs 140 shown by the column Machine Name 801.

The column 803 stores the frequencies of the CPUs 200 of computers 120 allocated to the VMs 140 shown by the column Machine Name 801.

The column Memory 804 stores the memory capacities 210 of computers 120 allocated to the VMs 140 shown by the column Machine Name 801.

The Column Number 805 stores the number of cores included by the CPUs 200 of computers 120 allocated to the VMs 140 shown by the column Machine Name 801.

The column Server Name 806 stores names for uniquely identifying applications that run on the VMs 140.

FIG. 9 is an explanatory diagram showing an example of migration information 452 according to the first embodiment of the present invention.

The migration information 452 includes eight columns, and their names are Task ID 901, Migration ID 902, Migration Start Time 903, Migration End Time 904, Type 905, Migration Source Machine Name 906, Migration Destination Machine Name 907, and Standard Load 908.

The column ID 901 stores identifiers used for identifying respective tasks performed by the VMs 140 on which a migration is executed.

The column Migration ID 902 stores identifiers used for identifying respective pieces of migration processing. Here, a piece of migration processing is identified by the relevant migration source and migration destination, therefore the same migration ID 902 is given to migrations whose sources and destinations are the same.

The column Type 905 stores information about reservation types. To put it concretely, signs “occupied” or signs “provisionally reserved” are stored in the column Type 905.

The columns Migration Start Time 903 and Migration Time 904 show the execution times of respective pieces of migration processing.

In the case where the column Type 905 shows a sign “occupied”, only the corresponding column Migration Start Time 903 is used to store a migration start time. In the case where the column Type 905 shows a sign “provisionally reserved”, both corresponding columns Migration Start Time 903 and Migration End Time 904 are used to store a start time and an end time of a migration. To put it concretely, the start time of a provisional reservation period is stored in the column Migration Start Time 903 and the end time of the provisional reservation period is stored in the column Migration End Time 904.

In the case where the column Type 905 shows a sign “provisionally reserved”, the migration processing is executed during the provisional reservation period shown by the column Migration Start Time 903 and the column Migration End Time 904.

The column Migration Source Machine Name 906 stores identifiers used for identifying respective VMs 140 at migration sources.

The column Migration Destination Machine Name 907 stores identifiers used for identifying respective VMs 140 at migration destinations.

The column Standard Load 908 stores standard load values of respective VMs 140 at migration destinations. In addition, standard load values in the column Standard Load 908 are given only to records having signs “provisionally reserved” in the column Type 905.

As described later, during a provisional reservation period, migration processing is executed if the load of the corresponding VM 140 at a migration destination is not larger than the corresponding value shown by the column Standard Load 908.

FIG. 10 is an explanatory diagram showing an example of evaluation definition information 453 according to the first embodiment of the present invention.

The evaluation definition information 453 includes four columns, and their names are Evaluation Value 1001, Evaluation Item 1002, Evaluation Standard 1003, and Weight 1004.

The column Evaluation Value 1001 stores variables representing evaluation values. The column Evaluation Item 1002 stores the explanations of evaluation targets from which evaluation values are derived. The column Evaluation Standard 1003 stores the calculation standards of evaluation values. The column Weight 1004 stores weighting factors that represent the importance levels of evaluation values shown in the column Evaluation Value 1001.

In addition, the values shown in the column Weight 1004 can be changed by users. For example, if a user wants to attach importance to the frequencies of CPUs, the evaluation value in the column Weight 1004 corresponding to “b” in the column Evaluation Value 1001 can be set to be the largest.

The calculation method of evaluation values with the use of the evaluation definition information 453 will be described later.

FIG. 11 and FIG. 12 are explanatory diagrams showing examples of schedule information 454 according to the first embodiment of the present invention.

There is one piece of schedule information 454 for one computer 120.

FIG. 11 shows schedule information 454 in which a new VM 140 has not been reserved yet. FIG. 12 shows schedule information 454 in which the new VM 140 has already been reserved.

The schedule information 454 stores information about the reservation states of VMs 140. To put it concretely, the schedule information 454 stores information about the reservation periods and provisional reservation periods configured in the VMs 140. The schedule information 454 includes six columns, and their names are Machine Name 1101, Start Time 1102, End Time 1103, Type 1104, Task ID 1105, and Server Name 1106.

The column Machine Name 1101 stores identifiers used for uniquely identifying respective VMs 140 on the computers 120.

The columns Start Time 1102 and End Time 1103 show reservation periods or provisional reservation periods configured in VMs 140 shown by the column Machine Name 1101.

To put it concretely, if a reservation period is configured in a VM 140, the start time of the reservation period is stored in the corresponding column Start Time 1102, and the end time of the reservation period is stored in the corresponding column End Time 1103. If a provisional reservation period is configured in a VM 140, the start time of the provisional reservation period is stored in the corresponding column Start Time 1102, and the end time of the provisional reservation period is stored in the corresponding column End Time 1103.

The column Type 1104 stores information showing reservation types. To put it concretely, when a reservation period is configured, a sign “occupied” is stored in the corresponding field of the column Type 1104, and when a provisional reservation period is configured, a sign “provisionally reserved” is stored in the corresponding field of the column Type 1104.

The column ID 1105 stores identifiers used for identifying respective tasks performed by the VMs 140 shown by the column Machine Name 1101.

The column Server Name 1106 stores names for uniquely identifying applications that run on the VMs 140.

FIG. 13 is an explanatory diagram showing an example of reservation state information 455 according to the first embodiment of the present invention.

The reservation state information 455 includes eight columns, and their names are Task ID 1301, User ID 1302, Start Time 1303, End Time 1304, Provisional Reservation Period 1305, Migration 1306, CPU 1307, and Memory 1308.

The column ID 1301 stores identifiers used for identifying respective tasks performed on the VMs 140.

The column ID 1302 stores identifiers used for identifying users who request the reservations of VMs 140 that perform tasks shown by the column Task ID 1201.

The column Start Time 1303 and End Time 1304 stores user request periods.

To put it concretely, the column Start Time 1303 stores the start times of the user request periods. The column End Time 1304 stores the end times of the user request periods.

The column Provisional Reservation Period 1305 stores information whether provisional reservation periods are configured in VMs 140 allocated for performing tasks shown by the column Task ID 1301 or not. To put it concretely, in the case where provisional reservation period is configured in a VM 140, a sign “present” is stored in the corresponding field of the column Provisional Reservation Period 1305, and in the case where a provisional reservation periods is not configured in a VM 140, a sign “absent” is stored in the corresponding field of the column Provisional Reservation Period 1305.

The column Migration 1306 stores information whether VMs 140 allocated for performing tasks shown by the column Task ID 1301 are changed by the migration or not.

In other words, the information stored in the column Migration 1306 is information whether each of the tasks is performed by an allocation schedule that uses plural VMs 140.

To put it concretely, in the case where a migration is executed, a sign “present” is stored in the corresponding field of the column Migration 1306, and in the case where a migration is not executed, a sign “absent” is stored in the corresponding field of the column Migration 1306.

If one VM 140 has a free time long enough to include a user request period, a migration for performing the task needs not be performed. In other words, if one VM 140 has a free time sufficient for a user request period, the one VM 140 is preserved for the user request period. On the other hand, in the case where a migration is executed, free times of plural VMs 140 are continuously connected in terms of time, and a schedule that satisfies a user request period are created.

The column CPU 1307 stores CPU frequencies allocated to reserved VMs 140.

The column Memory 1308 shows memory capacities allocated to the reserved VMs 140.

FIG. 14A and FIG. 14B are explanatory diagrams showing examples of free resource information 456 according to the first embodiment of the present invention.

There is one piece of free resource information 456 for one computer 120.

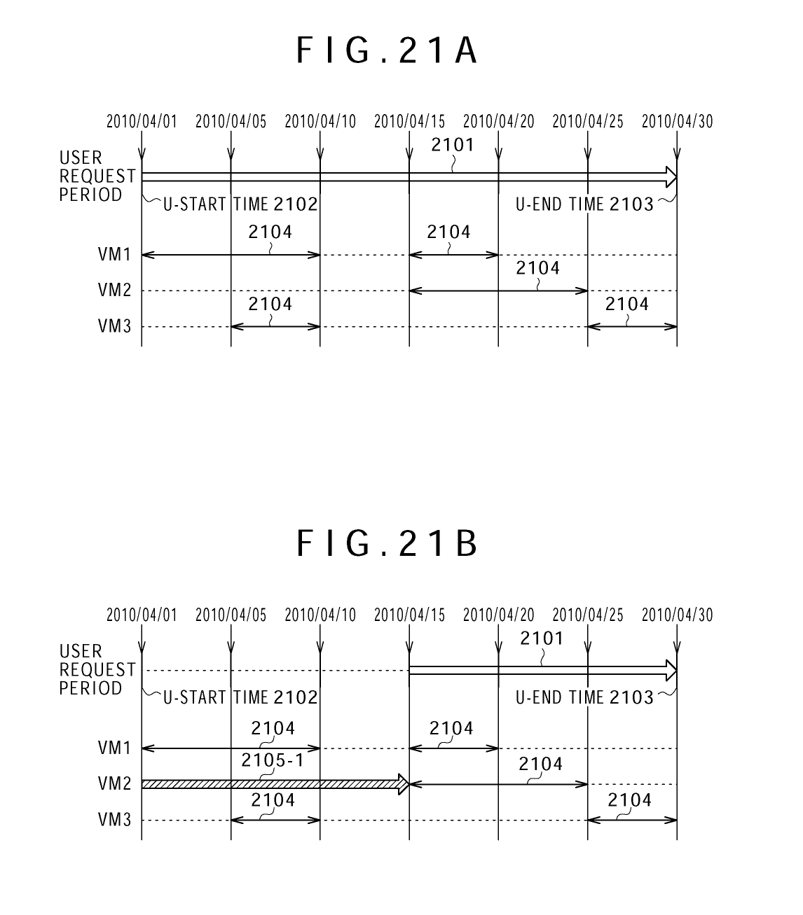

FIG. 14A shows free resource information 456 in which records have not been sorted yet in candidate list creation processing (refer to FIG. 19). FIG. 14B shows the free resource information 456 in which records have been sorted in candidate list creation processing (refer to FIG. 19).

The free resource information 456 includes five columns, and their names are ID 1401, Machine Name 1402, Start Time 1403, End Time 1404, and Type 1405.

The column ID 1401 stores identifiers used for identifying respective records recorded in the free resource information 456.

The column Machine Name 1402 stores identifiers used for identifying free resources, that is, VMs 140 that have free times.

The columns Start Time 1403 and End Time 1404 shows free times that VMs 140 have. To put it concretely, the column Start Time 1403 stores the start times of free times, and the column End Time 1404 stores the end times of the free times.

In addition, a sign “present time” in the column Start Time 1403 shows a time when the corresponding candidate list creation processing is executed. In addition, a sign “not yet determined” in the column End Time 1404 shows that the end time of the corresponding free time cannot be determined. In other words, a sign “not yet determined” in the column End Time 1404 shows that the corresponding VM is free all the times after the start time in the column Start Time 1403.

The column Type 1405 stores information about reservation types. Because the free resource information 456 stores only VMs 140 that have free times, the column Type 1405 stores a sign “free” showing that the corresponding resource is free.

FIG. 15 is an explanatory diagram showing an example of an operation screen output to the I/O device 340 according to the first embodiment of the present invention.

The I/O device 340 shows an operation screen 1500 shown in FIG. 15.

The operation screen 1500 includes an input part into which information necessary to create reservation models, and an output part on which the created reservation models are displayed. The operation screen 1500 is put into practice by the condition input part 350 and the result output part 360.

The operation screen 1500 includes a spec configuration button 1510, a creation button 1520, a creation condition input part 1530, a reservation model display part 1540, and a reservation button 1550.

The spec configuration button 1510 is an operation part used for configuring the configuration condition of a VM 140 to be reserved. When a user operates the spec configuration button 1510, the input part (not shown) used for configure the configuration condition of the VM 140 is displayed. For example, the input part, from which a CPU, memory capacity, and the like that are allocated to the VM 140 are input, is displayed.

The creation button 1520 is an operation part used for executing reservation processing. When a user operates the creation button 1520, a reservation request including information input from the input part is transmitted to the schedule management server 110. At this time, an user ID that is used for identifying the user that transmits the reservation request is also transmitted to the schedule management server 110.

Here, one conceivable method for acquiring a user ID is a method in which the user ID is acquired from logon information input by the user when he/she operates the management client 100.

The management server 110 that receives the reservation request executes reservation processing on the basis of the reservation request.

The creation condition input part 1530 is an input part used for inputting conditions for creating a reservation model. The creation condition input parts 1530 includes five columns, and their names are Migration Number 1531, Load Standard 1532, Provisional Reservation Period 1533, Start Time 1534, and End Time 1535.

The column Migration Number 1531 shows the number of migration executions.

The column Load Standard 1532 stores information about the load of a VM 140 at a migration destination. The column Load Standard 1532 stores, for example, a CPU usage rate allocated to a VM 140 at a migration destination. In the first embodiment, the load of a VM 140 is measured during a provisional reservation period. If the value of the measured load is equal to or lower than the value shown by the corresponding field of the column Load Standard 1532, a migration is executed.

The column provisional reservation period 1533 shows a provisional reservation period a user wants.

The columns Start Time 1534 and End Time 1535 show a user request period. To put it concretely, the column Start Time 1534 stores the start time of the user request period, and the column End Time 1535 stores the end time of the user request period.

The reservation model display part 1540 shows information about the created reservation models. The reservation model display part 1540 includes eight columns, and their names are Check 1541, Task ID 1542, Used Computers 1543, Migration Number 1544, Evaluation 1545, Minimum Frequency 1546, Usage Period 1547, and Provisional Reservation Period 1548.

The column Check 1541 is an operation part used for selecting a reservation model used in reservation configuration processing described later. A user can select a suitable model from the plural reservation models by operating the column Check 1541. Here, in the case where reservation configuration processing is automatically executed, the column Check 1541 is configured not to be operated.

The column Task ID 1542 stores identifiers used for identifying tasks performed by VMs 140.

The column Used Computer 1543 stores identifiers used for identifying VMs 140 to be used in the reservation models. A reservation period or a provisional reservation period is configured for a VM 140 shown by the column Used Computer 1543.

The column Migration Number 1544 stores the number of migration executions in each created reservation model.

The column Evaluation 1545 shows the evaluation values of the created reservation models.

The column Minimum Frequency 1546 shows the CPU frequencies allocated to the VMs 140 used in the created reservation models.

In a reservation model in which plural VMs 140 are used, the column Minimum Frequency 1546 stores a frequency that is the smallest of the frequencies of CPUs allocated to the plural VMs 140. Alternatively, it is conceivable that the column Minimum Frequency 1546 stores an average frequency of the frequencies of CPUs allocated to plural VMs 140 or the like.

The column Usage Period 1547 shows reservable periods of the created reservation models.

The column Provisional Reservation Period 1548 shows the lengths of the configured provisional reservation periods.

In a reservation model in which plural VMs are used, the column Provisional Reservation Period 1548 stores a provisional reservation period that is the shortest of the provisional reservation periods of plural VMs 140. Alternatively, it is conceivable that the column Provisional Reservation Period 1548 stores an average value of the provisional reservation periods of the plural VMs 140 or the like.

The reservation button 1550 is an operation part used for directing the execution of reservation configuration processing. When a user pushes the reservation button 1550, reservation configuration processing is executed on the basis of a reservation model selected in the column Check 1541.

Here, in the case where reservation configuration processing is automatically executed, the reservation button 1550 is set up not to be operated.

Next, reservation processing in the first embodiment will be described.

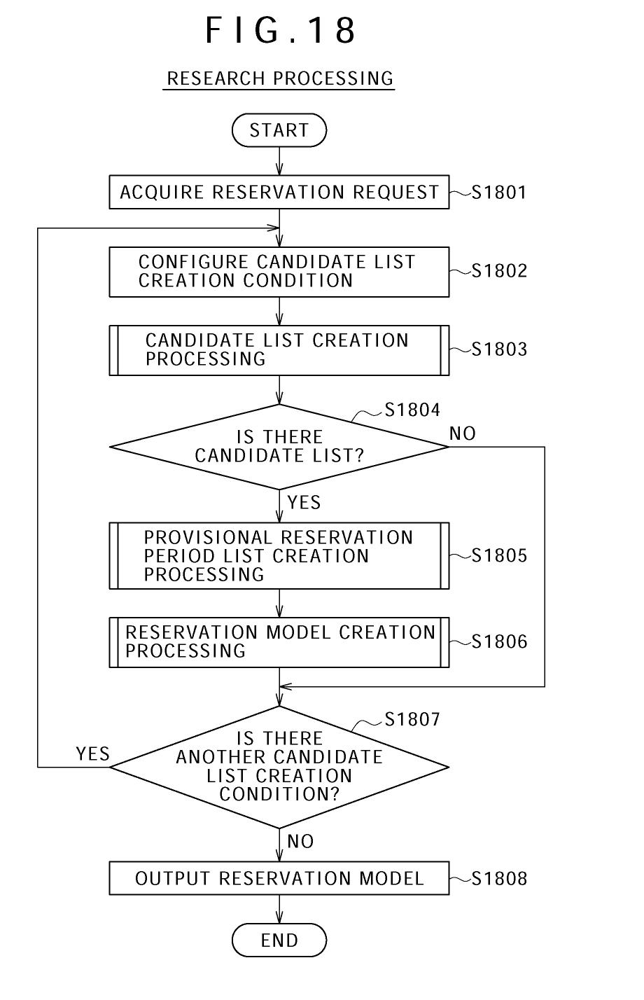

FIG. 16 is a flowchart describing an outline of reservation processing executed by the schedule management server 110 according to the first embodiment of the present invention.

On receiving a reservation request from the management client 100, the schedule management server 110 starts reservation processing (at step S1601). To put it concretely, the request acquisition part 449 receives the reservation request. The request acquisition part 449 temporarily stores the received reservation request on the memory 410. Here, the reservation request includes information input with the use of the operation screen 1500, and the user ID of a user who inputs the reservation request.

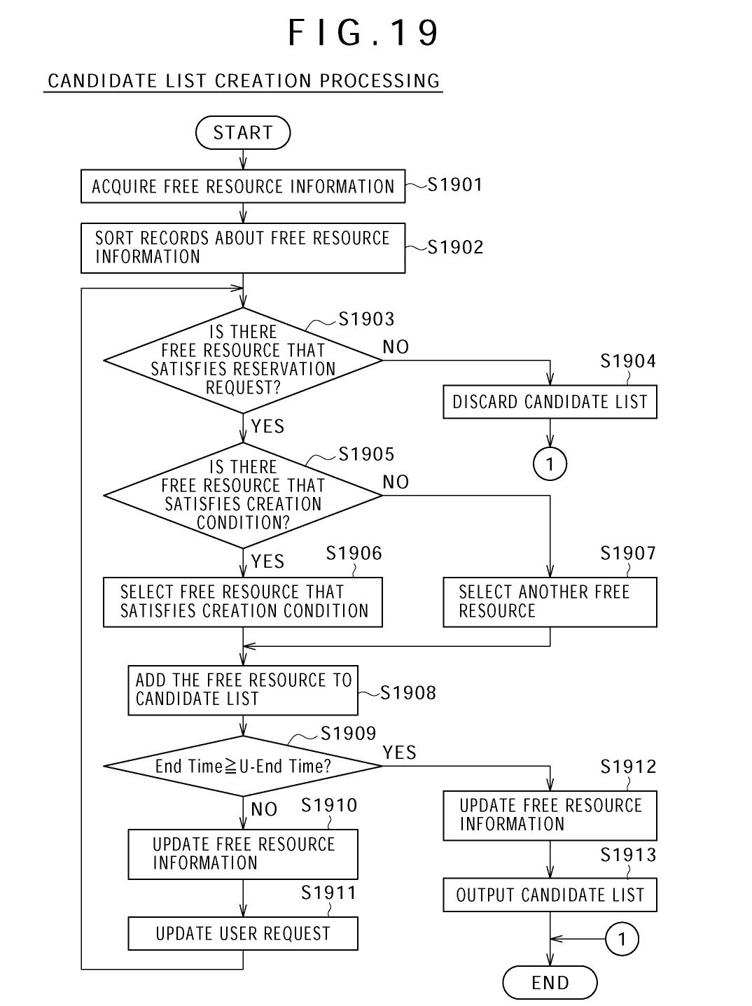

FIG. 17 is an explanatory diagram showing an example of a reservation request stored in the memory 410 according to the first embodiment of the present invention.

As shown in FIG. 17, a reservation request 1700 is held as a piece of information recorded in a table format.

The reservation request 1700 includes six columns, and their names are U-Start Time 1701, U-End Time 1702, Migration Number 1703, Load Standard 1704, Provisional Reservation Period 1705, and User ID 1706.

The column U-Start Time 1701 and U-End Time 1702 show a user request period. To put it concretely, the column U-Start Time 1701 stores the start time of the user request periods and the column U-End Time 1702 stores the end time of the user request period.

Here, the content of the column U-Start Time 1701 is the same as that of the column Start Time 1534, and the content of the column U-End Time 1702 is the same as that of the column End Time 1535.

The column Migration Number 1703 shows the number of migration executions. In the case where the column Migration Number 1703 shows a sign “0”, reservation processing for reserving only one VM 140 is executed. In other words, existing reservation processing is executed. In the case where the column Migration Number 1703 shows or “1” or “a larger number”, reservation processing with the use of plural VMs 140 is executed.

Here, the content of the column Migration Number 1703 is the same as that of the column Migration Number 1531.

The column Load Standard 1704 stores information about the load of a VM 140 at a migration destination. Here, the content of the column Load Standard 1704 is the same as that of the column Load Standard 1532.

The column Provisional Reservation Period 1705 shows a provisional reservation period a user wants. Here, the content of the column Provisional Reservation Period 1705 is the same as that of the column Provisional Reservation Period 1533.

The column User ID 1706 stores an identifier used for identifying a user who wants to reserve a VM 140.

In the reservation request 1700 of the first embodiment, at least the columns U-Start Time 1701, U-End Time 1702, and User ID 1706 have to store respective values. In other words, values have to be entered in the columns Start Time 1534 and End Time 1535 of the operation screen 1500.

If information is not stored in the columns of the operation screen 1500 other than the above columns, the reservation request does not include information about the columns Migration Number 1703, Load Standard 1704, and Provisional Reservation Period 1705.

In addition, it is conceivable that the reservation request 1700 includes the configuration information about a VM 140 to be reserved. The configuration information about the VM 140 is, for example, the frequency of a CPU and a memory capacity allocated to the VM 140.

Now, let's bring the topic back to FIG. 16.

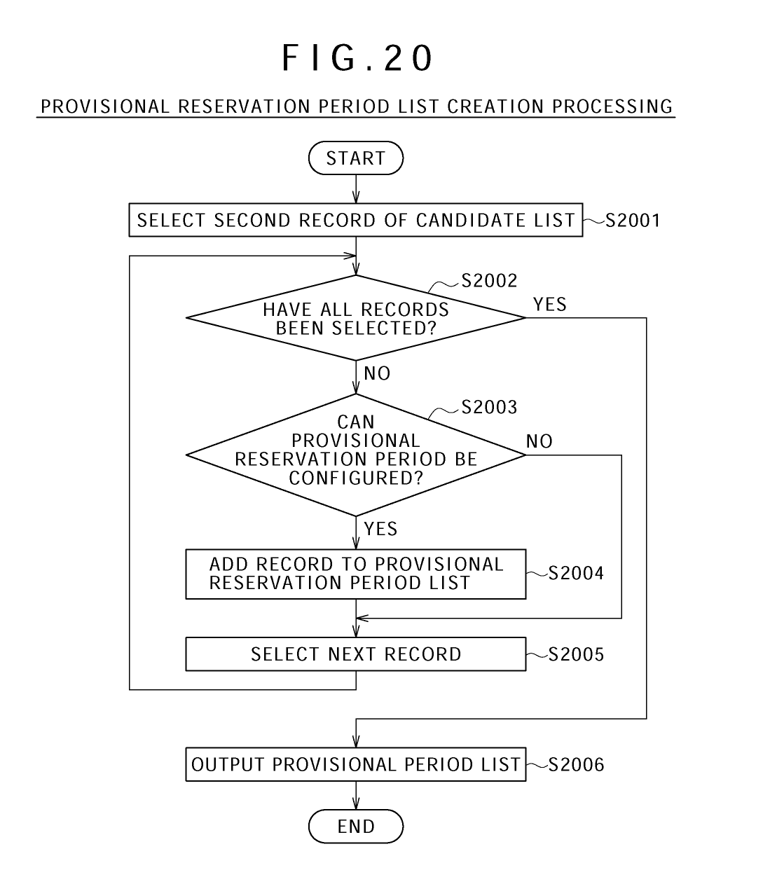

The schedule management server 110 executes search processing for searching reservable VMs 140 on the basis of the received reservation request (at step S1602). To put it concretely, the schedule management server 110 starts up the reservation model creation part 445, and the started-up reservation model creation part 445 executes the search processing. The search processing will be described in detail with reference to FIG. 18 later.

The schedule management server 110 outputs a search result (at step S1603). To put it concretely, a result output part 448 transmits a created reservation model to the management client 100. The management client 100 displays the created reservation model on the reservation model display part 1540 of the operation screen 1500 on the basis of information about the received reservation model.

The schedule management server 110 executes reservation configuration processing on the basis of the search result (at step S1604). To put it concretely, the schedule management part 442 executes the reservation configuration processing. The reservation configuration processing can be executed on the basis of the directions of the user who operates the management client 100, or can be automatically executed.

In the case where a user who operates the management client 100 directs the execution of the reservation configuration processing, the user directs the execution of the reservation configuration processing by selecting a reservation model he/she wants using the column Check 1541 of the reservation model display part 1540 and by pushing the reservation button 1550.

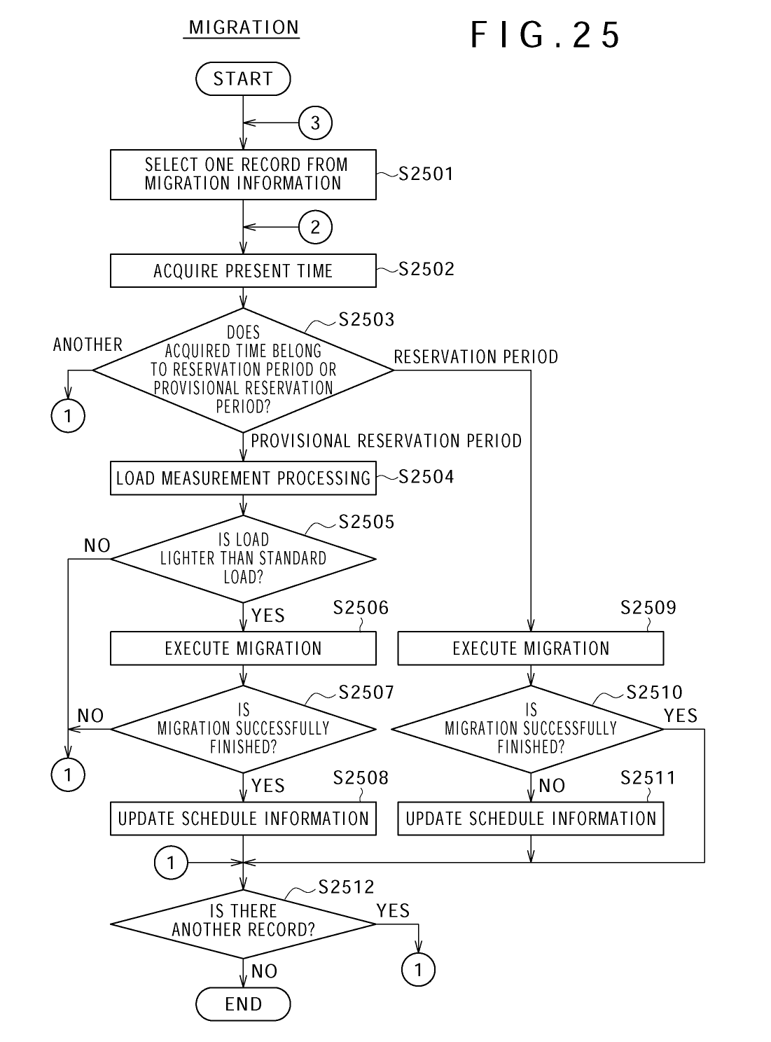

The reservation configuration processing will be described in detail with reference to FIG. 24 later.

The schedule management server 110 outputs the result of the reservation processing (at step S1605), and ends the processing. To put it concretely, the result output part 448 transmits the result of the reservation configuration processing to the management client 100.

FIG. 18 is a flowchart describing the search processing according to the first embodiment of the present invention.

First, the reservation model creation part 445 acquires the reservation request 1700 to be stored on the memory 410 (at step S1801).

Next, the reservation model creation part 445 configures a candidate list creation condition (at step S1802).

In addition, the reservation model creation part 445 holds one or more candidate list creation conditions in advance, and configures a candidate list creation condition by reading out one of the candidate list creation conditions.

As a candidate list creation condition, the following creation conditions are conceivable.

“Creation Condition 1”: Reserving a VM 140 that has the longest free time of the free times of the VMs 140.
“Creation Condition 2”: Reserving a VM 140 including a CPU that has the highest performance.
“Creation Condition 3”: Reserving a VM 140 that has a free time to which no provisional reservation period is allocated.

According to the first embodiment, one candidate list 461 is created for one candidate list creation condition.

The reservation model creation part 445 executes candidate list creation processing on the basis of the acquired reservation request 1700 and the configured candidate list creation condition (at step S1803). A candidate list 461 as shown in FIG. 5 is created by the processing. In addition, the created candidate list 461 is stored on the memory 410.

Here, candidate list creation processing will be described in detail with reference to FIG. 19 later.

The reservation model creation part 445 judges whether a candidate list 461 is created as a result of the candidate list creation processing or not (at step S1804). In other words, it is judged whether there is a VM 140 that satisfies both reservation request and candidate list creation condition or not.

In this judgment, for example, if a candidate list 461 such as shown in FIG. 5 is output, it is judged that a candidate list 461 is created.

If it is judged that a candidate list 461 is not created, the reservation model creation part 445 proceeds to step S1807.

If it is judged that a candidate list 461 is created, the reservation model creation part 445 executes provisional reservation period list creation processing on the basis of the created candidate list 461 (at step S1805). A provisional reservation period list 462 such as shown in FIG. 6 is created by this processing. In addition, the created provisional reservation period list 462 is stored on the memory 410.

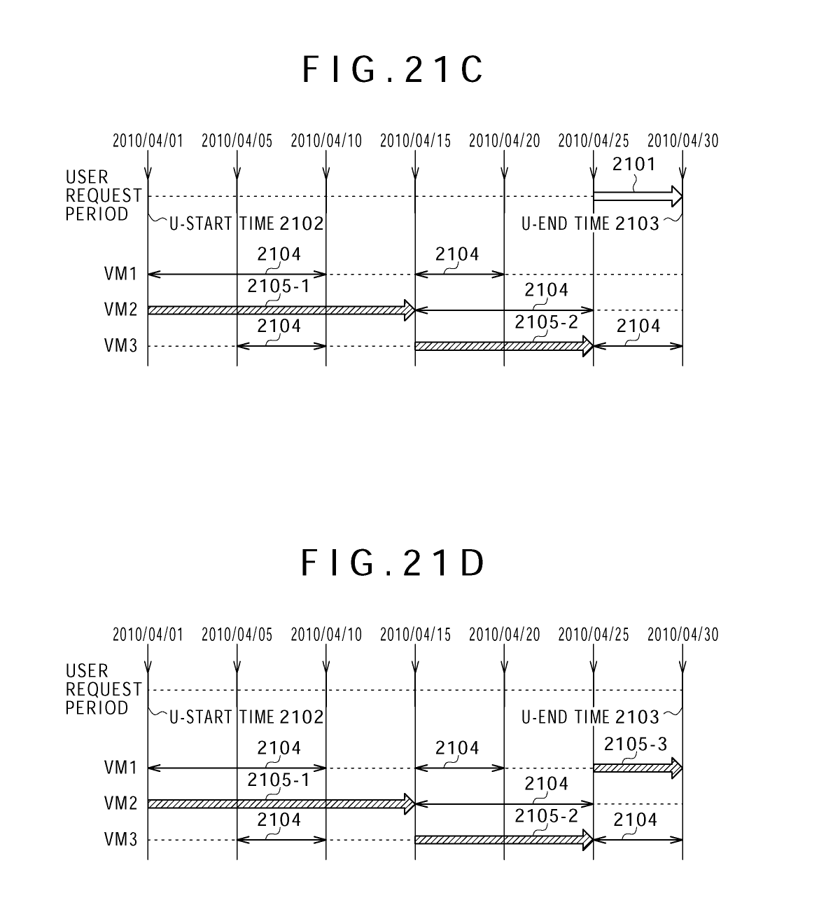

Here, the provisional reservation period list creation processing will be described in detail with reference to FIG. 20 later.

The reservation model creation part 445 executes reservation model creation processing on the basis of the created candidate list 461 and the created provisional reservation period list 462 (at step S1806). The reservation model creation part 445 makes the memory 410 store the reservation model 463 created by this reservation model creation processing.

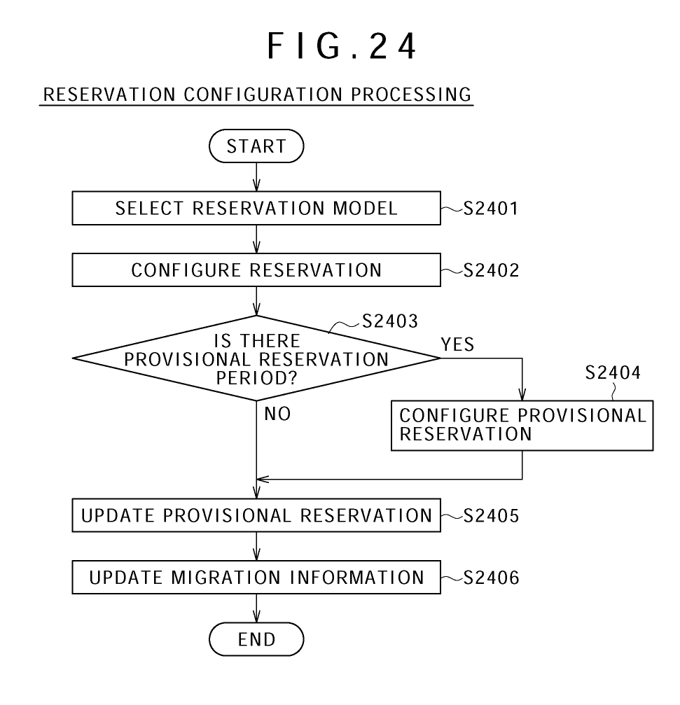

Here, the reservation model creation processing will be described in detail with reference to FIG. 23 later.

The reservation model creation part 445 judges whether there is another candidate creation condition or not (at step S1807). In other words, it is judged whether reservation models relevant to all candidate list creation conditions have been created or not.

If it is judged that there is another candidate creation condition, the reservation model creation part 445 goes back to step S1802, and executes processes similar to the above (step S1802 to step S1807) after configuring another candidate list creation condition.

If it is judged that there is not another candidate list creation condition, the reservation model creation part 445 outputs created reservation models 463 and calculated evaluation values (at step 1808), and ends the search processing. The output reservation models 463 and the calculated evaluation values are transmitted to the management client 100 by the result output part 448.

FIG. 19 is a flowchart describing candidate list creation processing according to the first embodiment of the present invention.

First, the reservation model creation part 445 acquires free resource information 456 (at step S1901). To put it concretely, the following processing is executed.

First, the reservation model creation part 445 starts up the free time detection part 444.

Next, the free time detection part 444 acquires the start time of the processing. Subsequently, the free time detection part 444 extracts the free times of VMs 140 in the units of the computers 120 with reference to the schedule information 454.

In the first embodiment, the free time detection part 444 extracts periods that are not configured as reservation periods or provisional reservation periods as free times for individual computers 120. In other words, periods that are configured as reservation periods or provisional reservation periods are not treated as free times.

The free time detection part 444 creates free resource information 456 such as shown in FIG. 14A on the basis of the extracted free times of VMs 140. As a result, the free resource information 456 of each computer 120 is created.

The created free resource information 456 is stored on the memory 410. Alternatively, the created free resource information 456 can be stored on the volatile storage medium 420.

The free time detection part 444 notifies the reservation model creation part 445 of the completion of the creation of the free resource information 456.

The reservation model creation part 445 reads out all pieces of the created free resource information 456 from the memory 410.

Next, the reservation model creation part 445 determines a computer 120 on which some VMs 140 are reserved on the basis of the read-out free resource information 456.

One of the selection method of the computer is, for example, as follows.

The reservation model creation part 445 calculates the sum of the free times of each computer on the basis of the free resource information 456 of each computer. The reservation model creation part 445 selects a computer that has the largest sum of free times calculated above. In other words, the computer 120 that has the largest sum of free resources is selected.

The reservation model creation part 445 executes the following processing on the basis of the free resource information 456 corresponding to the selected computer.

Next, the reservation model creation part 445 sorts records stored in the free resource information 456 with reference to values stored in the columns Start Time 1303 and End Time 1304 of the acquired free resource information 456 (at step S1902).

To put it concretely, the reservation model creation part 445 firstly sorts the records in the ascending order of the start times stored in the columns Start Time 1403 of the records. If there are plural records that has the same start times in the column Start Times 1403, the reservation model creation part 445 further sorts the plural records in descending order of the end times of the plural records in the columns End Time 1403.

For example, the records stored in the free resource information 456 shown in FIG. 14A are sorted so that the records are disposed as shown in FIG. 14B.

The processing time can be reduced by the above-mentioned sorting of the records stored in the free resource information 456.

The reservation model creation part 445 judges whether there is a VM 140 that satisfies the reservation request 1700 or not on the basis of the acquired reservation request 1700 and the free resource information 456 (at step s1903). To put it concretely, it is judged whether there is a VM 140 that satisfies the following two conditional expressions (1) and (2).

The value in the column U-Start Time≧The value in the column Start Time (1)

The value in the column U-End Time<The value in the column End Time (2)

Hereinafter, a VM 140 that satisfies both conditional expressions (1) and (2) will be referred to as a processing target VM 140.

In addition, if the reservation request includes VM 140 configuration information, the reservation model creation part 445 extracts VMs 140 that satisfy the VM 140 configuration information. On top of that, the reservation model creation part 445 judges whether there is a VM 140 that satisfies both conditional expressions (1) and (2) among the extracted VMs 140 or not.

Here, the VM 140 configuration information included in the reservation request is information input by the operation of the spec configuration button 1510.

If it is judged that there is no processing target VM 140, the reservation model creation part 445 discards the candidate list 461 (at step S1904), and ends the processing.

If it is judged that there is a processing target VM 140, the reservation model creation part 445 judges whether there is a VM 140 that satisfies the configured candidate list creation condition among the processing target VMs 140 or not (at step S1905).

For example, if the configured candidate list creation condition is “Creation Condition 1”, it is judged whether there is a processing target VM 140 that has the longest free time or not. If the configured candidate list creation condition is “Creation Condition 3”, it is judged whether a provisional reservation period is configured in the free time of each processing target VM 140 or not. To put it concretely, it is judged whether the item in the column Type 1405 of each processing target VM 140 is “provisionally reserved” or not.

If it is judged that there is no processing target VM 140 that satisfies the configured candidate list creation condition among processing target VMs 140, the reservation model creation part 445 selects another free resource (step S1907).

For example, as a method for selecting processing target VMs 140, a method for selecting processing target VMs 140 in the order of a processing target VM 140 corresponding to the highest sorted record to a processing target VM corresponding to the lowest sorted record is conceivable.

If it is judged that there are some processing target VMs 140 that satisfy the configured candidate list creation condition among processing target VMs 140, the reservation model creation part 445 selects one VM 140 out of the processing target VMs 140 that satisfy the configured candidate list creation condition (at step S1906).

In addition, if there are plural VMs 140 that satisfy the configured candidate list creation condition, a method for selecting processing target VMs 140 in the order of a processing target VM corresponding to the highest sorted record to a processing target VM 140 corresponding to the lowest sorted record is conceivable.

The reservation model creation part 445 adds a record corresponding to the selected VM 140 to the candidate list 461 (at step S1908).

Next, with reference to the column End Time 504 of the record added to the candidate list 461, the reservation model creation part 445 judges whether the time in the column End Time 504 shows a later time than that in the column U-End Time 1702 or not (at step S1909). In other words, it is judged whether the configuration of a schedule that satisfies the user request period has been completed or not.

For example, if the time in the column End Time 504 is “Apr. 25, 2010 23:59” and the time in the column U-End Time 1702 is “Apr. 30, 2010 23:59”, it is judged that the configuration of a schedule that satisfies the user request period has not been completed.

If it is judged that the time in the column End Time 504 shows an earlier time than that in the column U-End Time 1702, that is, if it is judged that the configuration of a schedule that satisfies the user request period has not been completed, the reservation model creation part 445 updates the free resource information 456 (at step S1910). In other words, the time corresponding to the reservation period of the added VM 140 is deleted from the free time of the VM 140 corresponding to the added record.

As an update method, a method in which the time acquired by subtracting one minute from the time shown by the column U-Start Time 1701 is set as the time shown by the column End Time 1404 of the record corresponding the added VM 140 is conceivable for example.

For example, if the time shown by the column End Time 1404 of a VM 140 corresponding to the added record is “Apr. 14, 2010 23:59” before update and the time shown by the column U-Start Time 1701 is “Apr. 1, 2010 00:00” before the update, the time shown by the column End Time 1404 is changed to “Mar. 31, 2010 23:59”.

Next, the reservation model creation part 445 updates the reservation request 1700 (at step S1911), goes back to step S1903, and executes processes similar to the above (step S1903 to step S1912).

To put it concretely, the time acquired by adding one minute to the time shown by the column End Time 504 of the added record is stored as the time shown by the column U-Start Time 1701. For example, if the time shown by the column End Time 504 is “Apr. 10, 2010 22:59”, the time shown by the column U-Start Time 1701 is changed to “Apr. 10, 2010 23:00”.

The above is done for deleting the period to the time shown by the column End Time 504 of the record added to the candidate list 461 from the period shown by the reservation request because the VM 140 whose free time has the end time shown by the column End Time 504 is reserved.

At step S1909, if it is judged that the time shown by the column End Time 504 shows an equal or later time than that shown by the column U-End Time 1702, the reservation model creation part 445 updates the free resource information 456 (at step S1912). A method for updating the free resource information 456 is the same as used at step S1910.

The reservation model creation part 445 outputs the created candidate list 461 (at step S1913), and ends the processing.

Although, in this first embodiment, reservable VMs 140 are searched with the use of free resource information 456, a method for searching the reservable VMs 140 is not limited to this method. For example, whether each VM 140 has a free time/free times or not can be judged with reference to the schedule information 454. In this case, the schedule management server 110 needs not store the free resource information 456.

In addition, it is conceivable that, after discarding the candidate list 461 at step 1904, the reservation model creation part 445 goes back to step S1901, acquires free resource information 456 of another computer 120, and executes processes similar to the above (step S1901 to step S1913).

FIG. 20 is a flowchart describing provisional reservation period list creation processing according to the first embodiment of the present invention.

The reservation model creation part 445 selects a record that has “2” in the column ID 501 with reference to the created candidate list 461 (at step S2001).

Next, the reservation model creation part 445 judges whether all the records of the candidate list 461 have been selected or not (at step S2002). In other words, it is judged whether this provisional reservation period list creation processing has been executed on all the records of the candidate list 461 or not.

If it is judged that all the records of the candidate list 461 have not been selected, the reservation model creation part 445 judges whether a VM 140 corresponding to the machine name shown by the column Machine Name 502 has free time for configuring the provisional reservation period with reference to the free resource information 456.

To put it concretely, the reservation model creation part 445 judges whether a VM 140 corresponding to the selected record has a free time for configuring the provisional reservation period that a user wants before the start time of the configured reservation period shown by the column Start Time 503 or not.

For example, in the case where the machine name shown by the column Machine Name 502 is “VM2” and the time shown by the column Start Time 503 is “Apr. 15, 2010 10:00”, it is judged whether VM2 has a free time for configuring a provisional reservation period (for example, one hour) before “Apr. 15, 2010 09:59” or not.

In this case, the length of the provisional reservation period can be specified by a user or can be defaulted in advance. In this first embodiment, a hot migration is used. In the hot migration, information can be instantaneously transmitted from a VM 140 at the migration source to a VM 140 at the migration destination. Therefore, the provisional reservation period can be shorter than the time needed for normal migration processing. However, it is necessary to secure the time needed for measuring the load of the VM 140 at the migration destination.

If it is judged that a VM 140 corresponding to the machine name shown by the column Machine Name 502 does not have a free time large enough to configure the provisional reservation period, the reservation model creation part 445 proceeds to step S2005.

If it is judged that the VM 140 corresponding to the machine name shown by the column Machine Name 502 has a free time large enough to configure the provisional reservation period, the reservation model creation part 445 adds the VM 140 corresponding to the machine name shown by the column Machine Name 502 to the provisional reservation period list 462 (step S2004).

For example, the reservation model creation part 445 adds a free time whose length is one hour at a maximum before the time shown by the column Start Time 503 of the selected record to the record of the provisional reservation list 462.

The reservation model creation part 445 selects the next record with reference to the candidate list 461 (at step S2005), goes back to step S2001, and executes processes similar to the above (step S2001 to step S2005).

If it is judged that all the records of the candidate list 461 have been selected at step S2002, the reservation model creation part 445 outputs the created provisional reservation period list 462 (at step S2006), and ends the provisional reservation period list creation processing.

At step S2004, if the length of the provisional reservation period is not specifically set, it is conceivable that the reservation model creation part 445 configures the entirety of a free time of a record as a provisional reservation period and adds the record to the provisional reservation period list 462.

Hereinafter, the concrete examples of candidate list creation processing and provisional reservation period list creation processing will be described.

For the purpose of simplifying the descriptions, the following assumptions will be set up. The time is defined by years, months, and days; that is, hours, minutes, and seconds are not taken into consideration in the definition of the time. In addition, it will be assumed that (Creation Condition 1) is selected as a candidate list creation condition. In addition, a reservation period and a provisional reservation period are configured in advance. In addition, the length of the provisional reservation period is one hour.

First, a concrete example of the candidate list creation processing will be described.

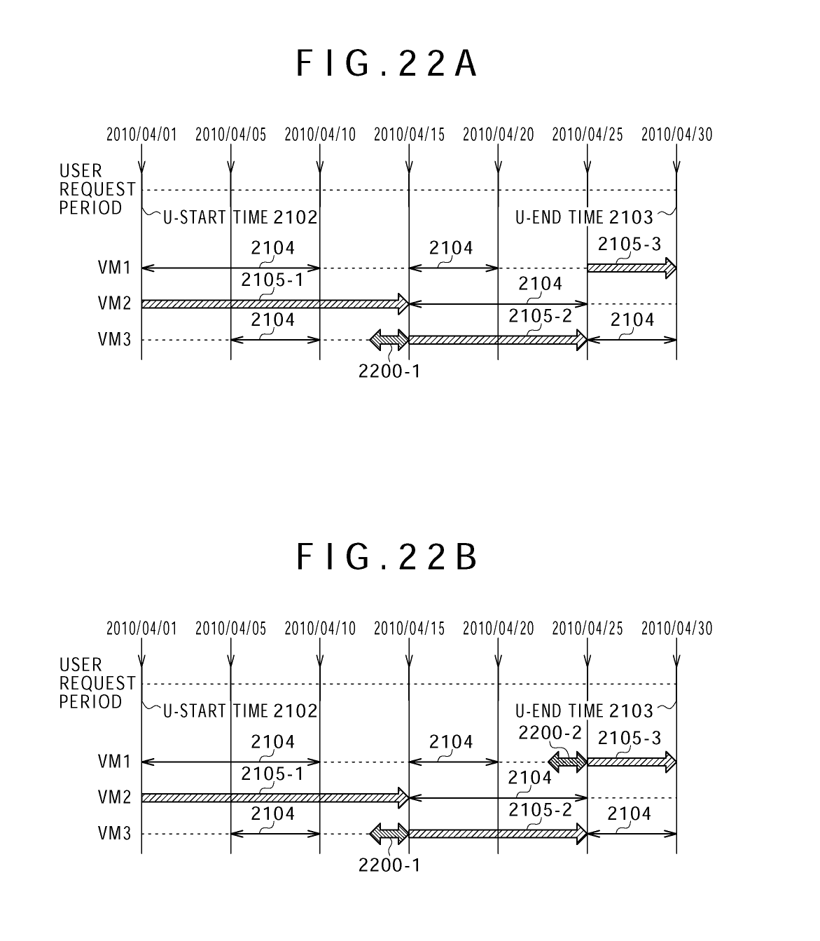

FIGS. 21A, 21B, 21C, and 21D are explanatory diagrams showing concrete examples of candidate list creation processing according to the first embodiment of the present invention.

As shown in FIG. 21A, the time shown the column U-Start Time 1701 is “Apr. 1, 2010”, and the time shown by the column U-End Time 1702 is “Apr. 30, 2010”.

In addition, the reservation state of the VMs 140 of a computer 120 is as shown in FIG. 21A. In other words, plural reservation periods 2104 have already been configured. A new reservation period 2104 cannot be configured during the periods during which the reservation periods 2104 have already been configured.

To put it concretely, the period between “Apr. 1, 2010” and “Apr. 10, 2010” and the period between “Apr. 15, 2010” and “Apr. 20, 2010” have already been reserved on the VM1. The period between “Apr. 15, 2010” and the period between “Apr. 25, 2010” has already been reserved on the VM2. The period between “Apr. 5, 2010” and “Apr. 10, 2010” and the period between “Apr. 25, 2010” and “Apr. 30, 2010” have already been reserved on the VM1.

In the above-described reservation state, the following processes are executed.

At step S1901, the reservation model creation part 445 acquires free resource information 456 that has a record of periods from “Apr. 20, 2010” to “Apr. 26, 2010” and from “Apr. 20, 2010” to “Apr. 30, 2010” on the VM1; a record of periods from “Apr. 2, 2010” to “Apr. 15, 2010” and from “Apr. 25, 2010” to “Apr. 30, 2010” on the VM2; and a record of periods from “Apr. 1, 2010” to “Apr. 5, 2010” and from “Apr. 10, 2010” to “Apr. 25, 2010” on the VM3.

At step S1903, the reservation model creation part 445 extracts the period from “Apr. 1, 2010” to “Apr. 15, 2010” on the VM2, and the period from “Apr. 1, 2010” to “Apr. 5, 2010” on the VM3 as free times that satisfy the reservation request.

Next, at step S1905, the reservation model creation part 445 selects a record that has a longer free time, that is, the record that has the period from “Apr. 1, 2010” to “Apr. 15, 2010” on the VM2. As a result, the record that has a reservation period 2105-1 is added to the candidate list 461.

At step S1909, because the time shown by the column End Time 504 of the added record is “Apr. 15, 2010”, the flow proceeds to step S1910.

At step S1910, a process for deleting the free time from “Apr. 1, 2010” to “Apr. 15, 2010” on the VM2 from the free resource information 456 is executed.

At step S1911, the time shown in the column U-Start Time 1701 is changed to “Apr. 15, 2010”.

When the above processes are finished, the reservation state of the VMs becomes as shown in FIG. 21B. Starting from the reservation state shown in FIG. 21B, the following processes are executed.

At step S1903, the reservation model creation part 445 extracts the period from “Apr. 5, 2010” to “Apr. 25, 2010” on the VM3 as a free time that satisfies the reservation request.

Next, at step S1905, the reservation model creation part 445 selects the period from “Apr. 5, 2010” to “Apr. 25, 2010” on the VM3. As a result, the record that has a reservation period 2105-2 is added to the candidate list 461.

At step S1909, because the time shown by the column End Time 504 of the added record is “Apr. 25, 2010”, the flow proceeds to step S1910.

At step S1910, a process to delete the free time from “Apr. 15, 2010” to “Apr. 25, 2010” on the VM3 from the free resource information 456 is executed.

At step S1911, the time shown in the column U-Start Time 1701 is changed to “Apr. 25, 2010”.

When the above processes are finished, the reservation state of the VMs becomes as shown in FIG. 21C. Starting from the reservation states shown in FIG. 21C, the following processes are executed.

At step S1903, the reservation model creation part 445 extracts the period from “Apr. 20, 2010” to “Apr. 30, 2010” on the VM1, and the period from “Apr. 20, 2010” to “Apr. 30, 2010” on the VM3 as free resources that satisfy the reservation request.

Next, at step S1905, the reservation model creation part 445 selects a record that has a longer free time, that is, the record that has the period from “Apr. 20, 2010” to “Apr. 30, 2010” on the VM1. As a result, the record that has a reservation period 2105-3 is added to the candidate list 461.

At step S1909, because the time shown by the column End Time 504 of the added record is “Apr. 30, 2010”, the flow proceeds to step S1912.

At step S1912, a process for deleting the free time from “Apr. 20, 2010” to “Apr. 30, 2010” on the VM1 from the free resource information 456 is executed.

At step S1913, the reservation model creation part 445 outputs the created candidate list 461, and ends the candidate list creation processing.

When the above processes are finished, the reservation state of the VMs becomes as shown in FIG. 21D. As shown in FIG. 21D, the reservation periods 2105-1, 2105-2, and 2105-3 can be combined so that these periods are continuous in terms of times, with the result that the user request period 2101 can be satisfied by reserving the VMs 140 in the above-described way.

As a result, an allocation schedule of VMs 140 in which the free times of VMs 140 can be effectively utilized is created.

In this embodiment, starting from the reservation states of the VMs as shown in FIG. 21D, provisional reservation period list creation processing is executed.

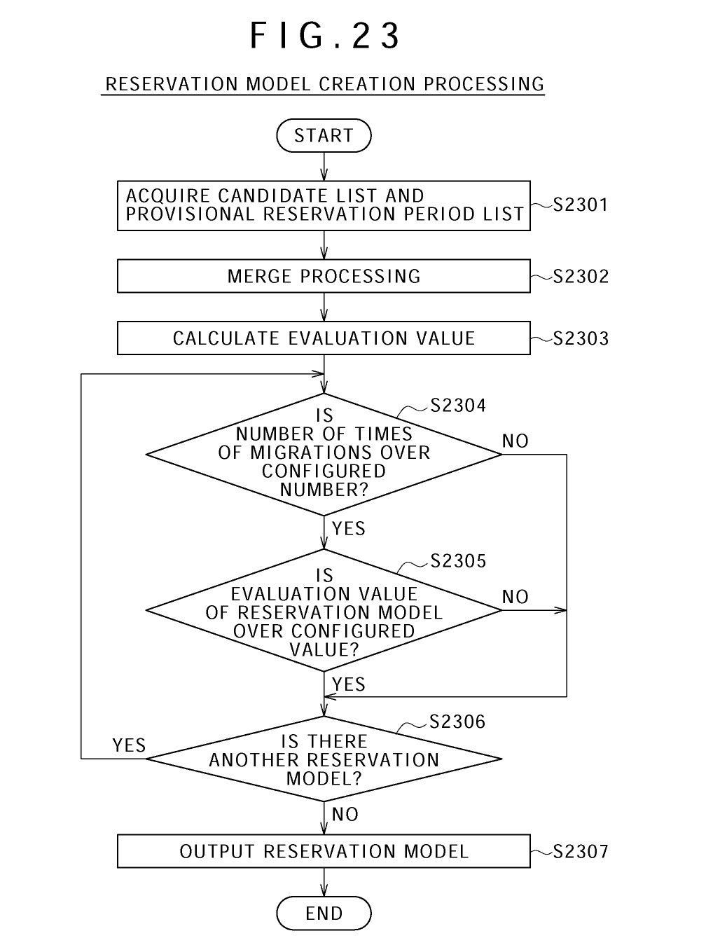

FIG. 22A and FIG. 22B are explanatory diagrams showing a concrete example of provisional reservation period list creation processing according to the first embodiment of the present invention.

First, at step S2001, the reservation model creation part 445 selects the record that has the reservation period 2105-2. At step S2002, because this provisional reservation list creation processing has not been executed on all the records of the candidate list 461, the reservation model creation part 445 goes to step S2003.

At step S2003, because the VM3 corresponding to the record having the reservation period 2105-2 has a free time longer than one hour before the reservation period 2105-2, that is, before “Apr. 15, 2010”, a record that has a period from the time one hour before “Apr. 15, 2010” to “Apr. 15, 2010” as a provisional reservation period 2200-1 is added to the provisional reservation list 462.

When the above processes are finished, the state of the VMs becomes as shown in FIG. 22A. Starting from the state shown in FIG. 22A, the following processes are executed.

At step S2005, the reservation model creation part 445 selects the record that has the reservation period 2105-3.

At step S2002, because this provisional reservation list creation processing has not been executed on all the records of the candidate list 461, the reservation model creation part 445 goes to step S2003.

At step S2003, because the VM1 corresponding to the record having the reservation period 2105-3 has a free time longer than one hour before the reservation period 2105-3, that is, before “Apr. 25, 2010”, a record that has a period from the time one hour before “Apr. 25, 2010” to “Apr. 25, 2010” as a provisional reservation period 2200-2 is added to the provisional reservation list 462.

At step S2005, because there is no other record, the reservation model creation part 445 goes to step S2002 without selecting any record.

At step S2002, it is judged that the provisional reservation period list creation processing has been executed on all the records of the candidate list 461, therefore the reservation model creation part 445 outputs a provisional reservation period list, and ends the provisional reservation period list creation processing.

When the above processes are finished, the state of the VMs becomes as shown in FIG. 22B.

FIG. 23 is a flowchart describing reservation model creation processing according to the first embodiment of the present invention.

The reservation model creation part 445 acquires the candidate list 461 and the provisional reservation period list 462 (at step S2301). It is to be noted that there is one provisional reservation period list 462 for one candidate list 461.

Next, a reservation model 463 as shown in FIG. 7 is created when the candidate list 461 and the provisional reservation period list 462 are merged by the reservation model creation part 445 (at step S2302). At this moment, all reservation models that satisfy the user request period are created.

The reservation model creation part 445 calculates the evaluation value of a created reservation model (at step S23203). To put it concretely, the following processing is executed.

The reservation model creation part 445 acquires the migration number of each created reservation model by counting the change numbers of the VMs 140 included each created reservation model. In addition, the reservation model creation part 445 acquires the frequencies of the CPUs on the basis of the machine names in the column Machine Name 702 of the reservation model 463 with reference to the configuration information 451. In addition, the reservation model creation part 445 acquires the provisional reservation periods of records that have “provisionally reserved” in the column of Type 705 of the created models with reference to the times shown by the columns Start Time 703 and End Time 704.

The reservation model creation part 445 calculates evaluation values on the basis of the acquired migration number, the CPU frequencies, and the provisional reservation periods with reference to the evaluation definition information 453. A evaluation value is calculated as follows for example.

Evaluation Value Y=3×a+2×b+1×c,

where a, b, and c are values shown in the column Evaluation Value 1001 of the evaluation definition information 453. In addition, the coefficients multiplied by the values a, b, and c are values shown in the column Weight 1004.

Next, the reservation model creation part 445 selects one reservation model, and repeatedly executes the processes of steps S2304 to S2306.

First, the reservation model creation part 445 judges whether the migration number of the selected reservation model is equal to or smaller than the preset migration number or not (at step S2304). In other words, it is judged whether the migration number of the selected reservation model is equal to or smaller than the number shown by the column Migration Number 1703.

In addition, if a value is not set in the column Migration Number 1531, it is judged that the migration number of the selected reservation model is equal to or less than the number in the column Migration Number 1703.

If it is judged that the migration number of the selected reservation model is larger than the number in the column Migration Number 1703, the reservation model creation part 445 discards the selected reservation model, and goes to step S2306.

If it is judged that the migration number of the selected reservation model is equal to or less than the number in the column Migration Number 1703, the reservation model creation part 445 judges whether the evaluation value of the selected reservation model is equal to or larger than a specified threshold or not (at step S2305). In addition, the threshold is a value specified in advance.

If it is judges that the evaluation value of the selected reservation model is smaller than the specified threshold, the reservation model creation part 445 discards the selected reservation model, and goes to step S2306.

If it is judges that the evaluation value of the selected reservation model is equal to or larger than the specified threshold, the reservation model creation part 445 judges whether there is another reservation model or not (at step S2306). In other words, it is judged whether the reservation model creation processing has been executed on all the reservation models or not.

If it is judged that there is another reservation model, the reservation model creation part 445 selects one reservation model, goes to step S2304 and executes processes similar to the above (step S2304 to step S2306).

If it is judged that there is no other model, the reservation model creation part 445 gives task IDs to reservation models that are not discarded in steps S2304 to S2306, outputs the reservation models that are given the task IDs (at step S2307), and ends the reservation model creation processing.

In the case where the reservation request includes only a user request period, all available reservation models are output.

Alternatively, in the case where both conditions for a reservation model at the judgment of step S2304 and at the judgment of step S2305 are not satisfied, a method, in which a flag meaning that both conditions are not satisfied is attached to the reservation model and the reservation model is output, is conceivable.

In this case, the reservation model with the above-mentioned flag is highlighted on the reservation model display part 1540 of the operation screen 1500. This makes it possible for a user to grasp all the selectable reservation models. In addition, the user can select a reservation model while confirming reservation models that do not satisfy both of the above conditions.

FIG. 24 is a flowchart describing reservation configuration processing according to the first embodiment of the present invention.

The schedule management part 442 selects a reservation model (at step S2401). In this case, there are two methods for selecting a reservation model: one is a method for a user to select a reservation model, and the other is a method for the schedule management part 442 to select a reservation model.

In the case where a user selects a reservation model, a method in which the user selects the reservation model by operating the column Check 1541 is conceivable.

In the case where the schedule management part 442 selects a reservation model, a method in which a reservation model that has the largest evaluation value is selected is conceivable. Alternatively, it is conceivable that the schedule management part 442 selects a reservation model on the basis of other standards.

The schedule management part 442 updates the schedule information 454 on the basis of the selected reservation model (at step S2402).

To put it concretely, if the selected model have “occupied” in the column Type 705, the schedule management part 442 adds the selected record to the schedule information 454. In this case, a identifier that is the same as the task ID given at step S2307 is stored in the column Task ID 1105 (in FIG. 11).

The schedule management part 442 judged whether the selected reservation model includes a record relevant to a provisional reservation period or not (at step S2403). In other words, it is judged whether the selected reservation model includes a record having “provisionally reserved” in the column Type 705 or not.

If it is judged that the selected reservation model does not include a record relevant to a provisional reservation period, the schedule management part 442 goes to step S2405.

If it is judged that the selected reservation model includes a record relevant to a provisional reservation period, the schedule management part 442 adds the record relevant to the provisional reservation period to the schedule information 454 (at step 2404). In this case, an identifier that is the same as the identifier given at step S2402 is stored in the column Task ID 1105. In addition, a values is stored in the column Standard Load 908.

In addition, if the reservation request includes the value of load standard, the value is stored in the column Standard Load 908. On the other hand, if the reservation request does not include the value of load standard, a preset value is stored in the column Standard Load.

The schedule management part 442 updates the reservation state information 455 on the basis of the selected reservation model (at step S2405).

To put it concretely, the following processing is executed.

The schedule management part 442 sets a task ID, which is the same as that in the column Task ID 1105, in the column Task ID 1301.

The schedule management part 442 stores the start time of the user request period in the column Start Time 1303 of the reservation state information 455 and stores the end time of the user request period in the column End Time 1304.

If the selected reservation model includes a record having “provisionally reserved” in the column Type 705, the schedule management part 442 sets “present” in the corresponding field of the column Provisional Reservation Period 1305.

In addition, if the selected reservation model includes records of VMs that have different machine names in the column Machine Name 702, the schedule management part 442 sets “present” in the column Migration 1306.

In addition, with reference to the configuration information 451 using the machine names of the selected reservation model in the column Machine Name 702, the schedule management part 442 stores the configuration information 451 of the corresponding VMs 140 in the columns CPU 1307 and Memory 1308.

Next, the schedule management part 442 updates the migration information 452 on the basis of the selected reservation model (step S2406).

To put it concretely, the following processing is executed.

First, the schedule management part 442 judges whether a provisional reservation period is configured or not with reference to the column Type 705 of the reserved model.

If it is judged that a provisional reservation period is configured, the schedule management part 442 stores the value shown in the column Start Time 703 of the record, which has “provisionally reserved” in the column Type 705, in the column Migration Start Time 903, and stores the value shown in the column End Time 704 of the record in the column Migration End Time 904. In addition, the schedule management part 442 sets the machine name, the task ID, and the server name corresponding to the record.

Records that have “occupied” in the column 705 of the selected reservation models are updated as follows.

First, the schedule management part 442 reads out two records that have “occupied” in the column Type 705. If the machine names of the two records in the column Machine Name 702 are different from each other, the schedule management part 442 judges that a migration is executed, and stores the start time, which is shown in the column Start Time 703 of the record at the migration destination, in the column Migration Start Time 903.

The schedule management part 442 ends the reservation configuration processing after updating each information.

Next, migration processing, which is executed after the allocation schedule of VMs 140 is created, will be described.

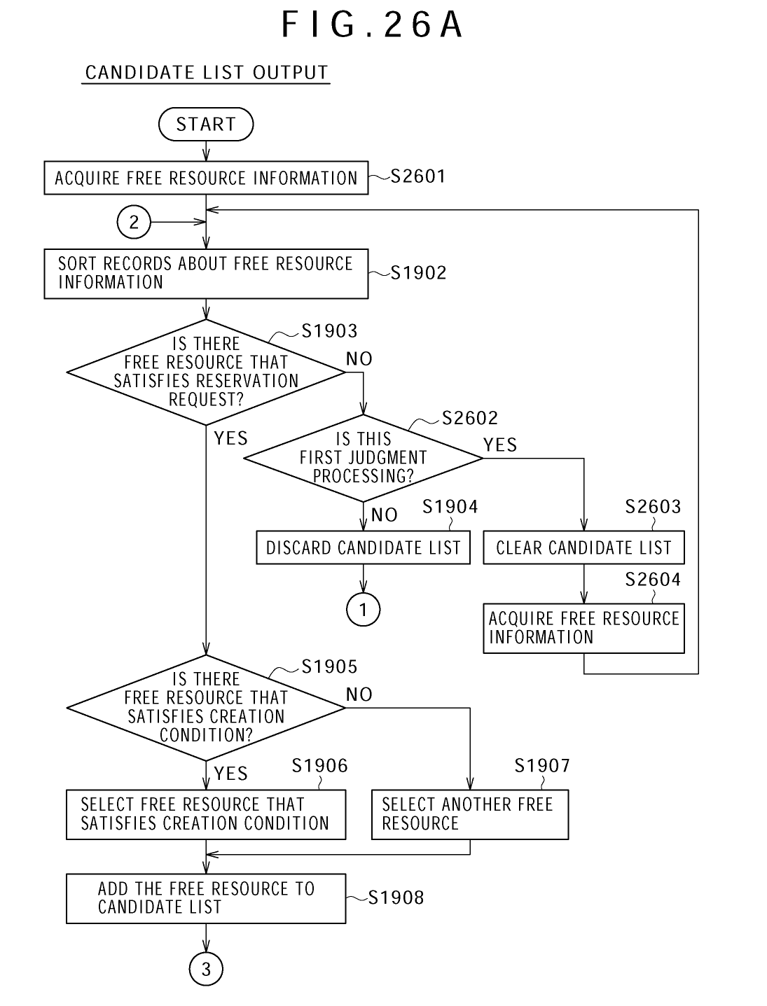

FIG. 25 is a flowchart describing migration processing according to the first embodiment of the present invention.

The schedule management part 442 periodically executes migration processing.

First, the schedule management part 442 selects one record from the migration information 452 (at step S2501). As a method for selecting a record, it is conceivable to select records stored in the migration information 452 in sequence.

The schedule management part 442 acquires the time of the start point of the processing (at step S2502).

The schedule management part 442 judges whether the acquired time coincides with the start time of a reservation period, the start time of a provisional reservation period, or not (at step S2503).

To put it concretely, the following processing is executed.

First, the schedule management part 442 judges whether the time shown by the column Migration Start Time 903 of the selected record coincides with the acquired time or not.

If it is judged that the time shown by the column Migration Start Time 903 of the selected record does not coincide with the acquired time, the schedule management part 442 goes to step S2512.

If it is judged that the time shown by the column Migration Start Time 903 of the selected record coincides with the acquired time, the schedule management part 442 examines the type of the acquired record shown by the column Type 905.

If the type of the acquired record in the column Type 905 is “provisionally reserved”, it is judged that the acquired time is the start time of the provisional reservation period. Therefore, the schedule management part 442 goes to step S2504.

If the type of the acquired record in the column Type 905 is “reservation”, it is judged that the acquired time is the start time of the reservation period. Therefore, the schedule management part 442 goes to step S2509.

If it is judged that the acquired time coincides with the start time of the reservation period, the schedule management part 442 orders the corresponding hypervisor 130 to execute a migration (at step S2509).

To put it concretely, the schedule management part 442 starts up the migration command part 447, and the migration command part 447 transmits a migration execution command to the hypervisor 130 that manages VMs 140 at the migration destination.

The migration execution command includes at least an task ID, an identifier of the VM 140 at the migration source, and an identifier of the VM 140 at the migration destination.

The hypervisor 130 that receives the migration execution command starts up the corresponding switching execution part 260. The started-up switching execution part 260 moves a guest OS 150 that performs a task corresponding the task ID from the VM 140 at the migration source to the VM 140 at the migration destination on the basis of the migration execution command. The switching execution part 260 transmits migration processing completion notification to the schedule management server 110.

The schedule management part 442 judges whether the migration has been successfully finished or not (at step S2510).

To put it concretely, the schedule management part 442 judges whether it receives the completion notification from the switching execution part 260 or not. If the schedule management part 442 receives the completion notification from the switching execution part 260, it is judged that the migration has been successfully finished. Alternatively, other judgment methods can be used.

If it is judged that the migration has been successfully finished, the schedule management part 442 goes to step S2512.

If it is judged that the migration has been unsuccessfully finished, the schedule management part 442 notifies the user of that fact that the migration has failed (at step S2511).

The schedule management part 442 judges whether there is a record that has not been selected or not (at step S2512).

If it is judged that there is a record that has not been selected, the schedule management part 442 goes back to step S2501, and executes processes similar to the above (step S2501 to step S2512).

At step S2503, if it is judged that the acquired time coincides with the start time of the provisional reservation period, the schedule management part 442 executes load measurement processing (at step S2504).

To put it concretely, the schedule management part 442 starts up the load measurement part 446, and the load measurement part 446 transmits a load information transmission command to the load information transmission part 250 of the VM 140 at the migration destination.

The schedule management part 442 judges whether a value included in the load information is equal to or less than the value shown in the column Standard Load 908 or not on the basis of the acquired load information (at step S2505).

If it is judged that the value included in the load information is larger than the value shown in the column Standard Load 908, the schedule management part 442 goes back to step S2502.

If the value included in the acquired load information is equal to or less than the value specified in the column Standard Load 908, the schedule management part 442 orders the corresponding hypervisor 130 to execute a migration (at step S2506). This process is the same as the process executed at step S2509.

The schedule management part 442 judges whether the migration has been successfully finished or not (at step S2507). This judgment is the same as the judgment made at step S2510.

If the migration has been unsuccessfully finished, the schedule management part 442 goes back to step S2502.

If the migration has been successfully finished, the schedule management part 442 updates the schedule information 454 (at step S2508).

To put it concretely, the schedule management part 442 stores the migration completion time in the column Start Time 1102 of the VM 140 at the migration destination. In addition, the schedule management part 442 deletes the record of the VM 140 at the migration source from the schedule information 454. As a result, one of the resources of the VM 140 at the migration source is released.

The schedule management part 442 judges whether there is a record that has not been selected or not (at step S2512).

If it is judged that there is a record that has not been selected, the schedule management part 442 goes back to step S2501, and executes processes similar to the above (step S2501 to step S2512).

As described above, during a provisional reservation period, when a load is equal to or less than a specified value, a migration is executed. In addition, if the migration has been unsuccessfully finished, the migration is executed again in the provisional reservation period. Because this enables the migration to be securely executed, the security and reliability of VMs 140 that perform tasks are improved.

According to the first embodiment of the present invention, even if there is no VM 140 that has a free time equal to or longer than a user request period, plural VMs 140 that satisfy the user request period with the use of free times possessed by the plural VMs 140 can be reserved. As a result, the short free times possessed by plural VMs 140 can be effectively utilized.

In addition, in the first embodiment, migration execution timing is managed by a provisional reservation period. During a provisional reservation period, a migration is executed in accordance with the load of a VM 140 at a migration destination. In addition, even in the case where migration processing has been unsuccessfully finished during a provisional reservation period, the migration processing can be again executed during the provisional reservation period. This enables the security and reliability of VMs 140 that perform tasks to greatly improve.

### Second Embodiment

Hereinafter, a second embodiment of the present invention will be described. In the second embodiment, candidate list creation processing in the case where a record relevant to a provisional reservation period is included in schedule information 454 is different from that in the first embodiment. Because other apparatus configurations and processing methods are the same as those in the first embodiment, explanations about these configurations and methods will be omitted.

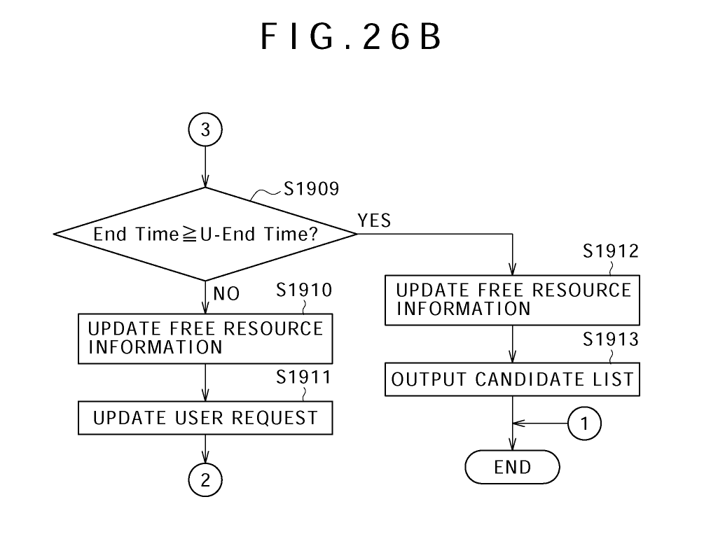

FIG. 26A and FIG. 26B are flowcharts describing candidate list creation processing according to the second embodiment of the present invention.

Processes that are the same as those in FIG. 19 are given the same reference numerals. Hereinafter, different points between the processes shown in FIG. 19 and the processes shown in FIG. 26A and FIG. 26B will be mainly described.

First, a reservation model creation part 445 acquires free resource information 456 that is created on the basis of free times during which any reservation periods or any provisional reservation periods are not configured (at step S2601). Here, the free resource information 456 is created by the following processing.

A free time detection part 444 extracts free times of records for each computer 120 with reference to the schedule information 454 except for free times of records that have “occupied” or “provisionally reserved” in the column Type 1104. In other words, free times during which any reservation periods and any provisional reservation periods are not configured are extracted.

Next, the free time detection part 444 creates free resource information 456 on the basis of the extracted free times. In this case, only records that have “free” in the column Type 1405 are stored in the created free resource information 456.

If it is judged that there is no free resource that satisfies a reservation request at step 1903, the reservation model creation part 445 judges whether this judgment process is the first one or not (at step S2602). This judgment can be done with the use of the number of judgment processes counted by the reservation model creation part 445.

If it is judged that this judgment is the first one, the reservation model creation part 445 clears a candidate list 461. To put it concretely, the value in the column U-Start Time 1701 is reset to an original value, and records are stored in the candidate list 461 are all deleted.

After the candidate list 461 is cleared, the reservation model creation part 445 acquires the free resource information 456 created on the basis of free times during which any reservation periods are not configured (at step S2604). In this case, the free resource information 456 is created by the following processes.

The free time detection part 444 extracts free times of records for each computer with reference to the schedule information 454 except for free times of records that have “occupied” in the column Type 1104. In other words, free times during which any reservation periods are not configured are extracted. As a result, free resource information 456 in which provisional reservation periods are treated as free times is created.

The free time detection part 444 creates the free resource information 456 on the basis of the extracted free times. In this case, records that have “free” and “provisionally reserved” in the column Type 1405 are stored in the created free resource information 456.

In addition, it is conceivable that the free time detection part 444 does not extract the entireties of the provisional reservation periods as free times. In this embodiment, it will be assumed that this embodiment is configured so that a period between one hour before the end time of each provisional reservation period (in the column End Time 1103) and the end time is not extracted. In this case, if the length of a provisional reservation period is four hours, a period of three hours from the start time (in the column Start Time 1102) of the provisional reservation period is extracted as a free time.

The reservation model creation part 445 judges whether there is a VM 140 that satisfies the reservation request or not on the basis of the created free resource information 456 (at step S1903).

If it is judged that the time in the column End Time 504 is equal to or larger than the time in the column U-End Time 1702 at step S1909, the reservation model creation part 445 updates the free resource information 456 (at step S1912).

In addition, the reservation model creation part 445 updates the schedule information 454 (at step S1913), and ends the processing. To put it concretely, the column Start Time 1102 and the column End Time 1103 of records, which have “provisionally reserved” in the columns Type 1104, are updated.

A part of a provisional reservation period that overlaps a time zone between a start time in the column Start Time 503 and an end time in the column End Time 504 is deleted. In addition, if the entirety of a provisional reservation period overlaps a time zone between a start time in the column Start Time 503 and an end time in the column End Time 504, a record which includes the provisional reservation period is deleted from the schedule information 454.

As an update method, a method that is the same as that used at step S1910 is used. However, a part of the method for updating the free resource information 456 created at step S2604 is a little different. To put it concretely, when a new reservation period is created in a provisional reservation period, a part of the provisional reservation period that corresponds to the new reservation period is deleted from the provisional reservation period. In other words, the new reservation period is configured using the provisional reservation period as a free time.

In addition, if a provisional reservation period is included by a reservation period, a record with the provisional reservation period is deleted from the free resource information 456.

In the second embodiment, a provisional reservation period is a period that can be used by other users for configuring a reservation period. In other words, a VM 140 that is in a provisional reservation state is not treated as in an occupied state, and is treated as a VM having a free time. As a result, flexible resource allocation and resource release can be put into practice.

### Modifications

In the migration processing according to the first embodiment, the migration is executed under the condition that the load of a VM 140 at a migration destination during a provisional reservation period is equal to or less than the value in the column Standard Load 908. However, in the present invention, the above condition is not only a condition for executing a migration, but also the following method can be used for executing the migration.

### First Modification

If it is judged that the acquired time is the start time of a provisional reservation period at step S2503, the schedule management part 442 orders a hypervisor 130 to monitor a job of a task executed on each VM 140.

The hypervisor 130 that receives the job monitoring command transmits a job completion notification to the schedule management part 442 when the hypervisor 130 detects that a job executed on each VM 140 at the migration source has been completed.

On receiving the job completion notification, the schedule management part 442 orders the hypervisor 130 to execute a migration.

In the first modification, the migration is executed with the completion of the job during the provisional period as a momentum.

### Second Modification

In a second modification, a hypervisor 130 includes a failure detection part (not shown) for monitoring failures of VMs 140.

In this modification, if it is judged that an acquired time is the start time of a provisional reservation period at step S2503, the schedule management part 442 orders the hypervisor 130 to monitor failures of VMs 140.

The hypervisor 130, which receives the command for monitoring the failures of the VMs 140, starts up the failure detection part (not shown) and makes the failure detection part monitor the failures of the VMs 140.

If a failure of a VM 140 at a migration source is detected, the hypervisor 130 transmits a failure notification including the identifier of the VM 140 at the migration source to the schedule management part 442.

The schedule management part 442 that receives the failure notification orders the hypervisor 130 to execute a migration.

On the other hand, if a failure of a VM 140 at a migration destination is detected, the hypervisor 130 transmits a failure notification including the identifier of the VM 140 at the migration destination to the schedule management part 442.

The schedule management part 442 that receives the failure notification notifies a user of the fact that the failure of the reserved VM 140 is detected.

In addition, when the failure of the VM 140 at the migration destination is detected, if there is an enough time interval to the end time of the provisional reservation period, the schedule management part 442 can execute the reservation processing again.

In the second modification of the present invention, a migration is executed with a failure of a VM 140 that occurs during a provisional reservation period with a momentum.

In addition, it is conceivable that a combination of the first embodiment, the first modification, and the second modification is used as an embodiment of the present invention.

Although there has been described in detail the present invention with reference to the accompanying drawings, the present invention shall in no way be limited by these concrete configurations, and may include various modifications and equivalent configurations without departing from the spirit and scope of the appended claims.

What is claimed is:

1. A schedule management method in a computer system comprising:
a terminal that a user operates;
a plurality of computers that perform a user task; and
a schedule management server that manages the allocation of the plurality of computers that perform the user task,
wherein the terminal includes:
a first processor;
a first memory that is connected to the first processor;
a first network interface that is connected to the first processor; and
an input/output part that is connected to the first processor, and
each of the plurality of computers includes:
a second processor;
a second memory that is connected to the second processor; and
a second network interface that is connected to the second processor,
the schedule management server includes:
a third processor;
a third memory that is connected to the third processor; and
a third network interface that is connected to the third processor,
wherein the second memory stores:
a virtual machine monitor that manages a plurality of virtual computers provided by virtually dividing the physical resources of the plurality computers; and
an operating system that runs on each of the virtual computers, and performs the user task, and
the third memory stores:
a request receiving part that receives a reservation request for reserving virtual computers to be allocated to the user task; and
a schedule management part that manages reservation information including the reservation state of each virtual computer, and creates a reservation schedule for each virtual computer allocated to the user task,
wherein a schedule creation method includes:
a first step in which the request receiving part receives the reservation request including a reservation request period that is wanted by the user and sent from the terminal;
a second step in which the schedule management part extracts a free period of each virtual computer, during which a new reservation period can be made, with reference to the reservation information;
a third step in which the schedule management part selects computers on which reservable virtual computers run on the basis of the received reservation request and the extracted free period of each virtual computer;
a fourth step in which a reservation schedule that secures a period that coincides with the reservation request period is created by reserving one virtual computer which runs on the selected computer, and another virtual computer which runs on the decided computer so that the end-point of a reservation period configured in the free period of the one virtual computer coincides with or overlaps the start-point of a reservation period configured in the free period of the another computer;
a fifth step in which the schedule management part updates the reservation information on the basis of the created reservation schedule; and
a sixth step in which the schedule management part migrates the user task from the virtual computer that is performing the user task to the another reserved virtual computer on the basis of the updated reservation information.

2. A schedule management method according to claim 1,
wherein, in the fourth step, the schedule management part creates the reservation schedule including the reservation period to be configured, and a provisional reservation period that is configured in a free period before the reservation period to be configured and shows a migration execution period.

3. A schedule management method according to claim 2,
wherein the fourth step includes:
a seventh step in which the schedule management part creates a first allocation schedule relevant to the reservation period to be configured;
an eighth step in which the schedule management part creates a second allocation schedule relevant to the provisional reservation period to be configured; and
a ninth step in which the schedule management part creates the reservation schedule on the basis of the created first allocation schedule and the created second allocation schedule.

4. A schedule management method according to claim 3,
wherein the schedule management part holds a plurality of creation conditions for creating the first allocation schedule (for each virtual computer);
the reservation request includes selection criterion information for selecting a reservation schedule;
the schedule management part creates one first allocation schedule for each creation condition in the seventh step;
the schedule management part creates one second allocation schedule corresponding to each created first allocation schedule in the eighth step;
the schedule management part creates a plurality of reservation schedules on the basis of the plurality of first allocation schedules and the corresponding plurality of second allocation schedules in the ninth step; and
the schedule management method includes a tenth step in which the schedule management part selects one reservation schedule out of the plurality of created reservation schedules on the basis of the received reservation request after the fourth step is executed.

5. A schedule management method according to claim 2,
wherein, in the sixth step, the schedule management part periodically acquires the hour;
the schedule management part judges whether the acquired hour is included in the configured provisional reservation period or not with reference to the reservation schedule on the basis of the acquired hour;
if it is judged that the acquired hour is included in the configured provisional reservation period, the schedule management part acquires the load that a virtual computer at the migration destination has; and
if the acquired load the virtual computer at the migration destination has is judged to be equal to or less than a specified threshold, the schedule management part migrates the user task performed on the virtual computer at the migration source to the virtual computer at the migration destination.

6. A schedule management method according to claim 2,
wherein, in the sixth step, the schedule management part periodically acquires the hour;
the schedule management part judges whether the acquired hour is included in the configured provisional reservation period or not with reference to the reservation schedule on the basis of the acquired hour;
if it is judged that the acquired hour is included in the configured provisional reservation period, the schedule management part monitors the execution state of a job of a virtual computer at the migration source on which the user task is performed; and
when the execution completion of the job is detected, the schedule management part migrates the user task performed on the virtual computer at the migration source to the virtual computer at the migration destination.

7. A schedule management method according to claim 2,
wherein, in the sixth step, the schedule management part periodically acquires the hour;
the schedule management part judges whether the acquired hour is included in the configured provisional reservation period or not with reference to the reservation schedule on the basis of the acquired hour;
if it is judged that the acquired hour is included in the configured provisional reservation period, the schedule management part monitors the failure of a virtual computer at the migration source on which the user task is performed; and
when the failure of the virtual computer at the migration source is detected, the schedule management part migrates the user task performed on the virtual computer at the migration source to the virtual computer at the migration destination.

8. A schedule creation method according to claim 2,
wherein a virtual computer to which a reservation period is allocated cannot be reserved during the reservation period;
a virtual computer to which a provisional reservation period is allocated can be reserved during the provisional reservation period; and
the schedule management part extracts the provisional reservation period as a free time on receiving a new reservation request.

9. A schedule management server that manages the allocation of a user task to virtual computers created by logically dividing physical resources of computers,
wherein the schedule management server includes a processor, a memory connected to the processor, and a network interface connected to the processor,
wherein the memory includes a request receiving part that receives a reservation request for reserving a virtual computer allocated to the user task,
a schedule management part that manages reservation information including the reservation state of each virtual computer, and creates a reservation schedule for each virtual computer allocated to the user task,
wherein the request receiving part receives the reservation request including a reservation request period that is wanted by the user, and
the schedule management part
extracts a free period of each virtual computer, during which a new reservation period can be made, with reference to the reservation information;
selects computers on which reservable virtual computers run on the basis of the received reservation request and the extracted free period of each virtual computer;
creates a reservation schedule that secures a period that coincides with the reservation request period by reserving one virtual computer which runs on the selected computer, and another virtual computer which runs on the decided computer so that the end-point of a reservation period configured in the free period of the one virtual computer coincides with or overlaps the start-point of a reservation period configured in the free period of the another computer;
updates the reservation information on the basis of the created reservation schedule; and
migrates the user task from the virtual computer that is performing the user task to the another reserved virtual computer on the basis of the updated reservation information.

10. A schedule management server according to claim 9,
wherein the schedule management part, when creating the reservation schedule, creates the reservation schedule including the reservation period to be configured for each virtual computer, and a provisional reservation period that is configured in a free time before the reservation period to be configured for each virtual computer and shows a migration execution period.

11. A schedule management server according to claim 10,
wherein the schedule management part, when creating the reservation schedule, creates:
a first allocation schedule relevant to the reservation period to be configured;
a second allocation schedule relevant to the provisional reservation period to be configured; and
the reservation schedule on the basis of the created first allocation schedule and the created second allocation schedule.

12. A schedule management server according to claim 11,
wherein the schedule management part holds a plurality of creation conditions for creating the first allocation schedule;
the reservation request includes selection criterion information for selecting a reservation schedule;
the schedule management part:
creates one first allocation schedule for each creation condition;
creates one second allocation schedule corresponding to each created first allocation schedule;
creates a plurality of reservation schedules on the basis of the plurality of first allocation schedules and the corresponding plurality of second allocation schedules; and
selects one reservation schedule out of the plurality of created reservation schedules on the basis of the received reservation request.

13. A schedule management server according to claim 10,
wherein the schedule management part:
periodically acquires the hour;
judges whether the acquired hour is included in the configured provisional reservation period or not with reference to the reservation schedule on the basis of the acquired hour;
acquires the load that a virtual computer at the migration destination has if it is judged that the acquired hour is included in the configured provisional reservation period; and
migrates the user task performed on the virtual computer at the migration source to the virtual computer at the migration destination if the acquired load the virtual computer at the migration destination has is judged to be equal to or less than a specified threshold.

14. A schedule management server according to claim 10,
wherein the schedule management part:
periodically acquires the hour;
judges whether the acquired hour is included in the configured provisional reservation period or not with reference to the reservation schedule on the basis of the acquired hour;
monitors the execution state of a job of a virtual computer at the migration source on which the user task is performed if it is judged that the acquired hour is included in the configured provisional reservation period; and
migrates the user task performed on the virtual computer at the migration source to the virtual computer at the migration destination when the execution completion of the job is detected.

15. A schedule management server according to claim 10,
wherein the schedule management part:
periodically acquires the hour;
judges whether the acquired hour is included in the configured provisional reservation period or not with reference to the reservation schedule on the basis of the acquired hour;
monitors the failure of a virtual computer at the migration source on which the user task is performed if it is judged that the acquired hour is included in the configured provisional reservation period; and
migrates the user task performed on the virtual computer at the migration source to the virtual computer at the migration destination when the failure of the virtual computer at the migration source is detected.

16. A schedule management server according to claim 10,
wherein a virtual computer to which a reservation period is allocated cannot be reserved during the reservation period;
a virtual computer to which a provisional reservation period is allocated can be reserved during the provisional reservation period; and
the schedule management part extracts the provisional reservation period as a free time on receiving a new reservation request.
